(19) United States
(12) Patent Application Publication
(10) Pub. No.: US 2024/0104470 A1
(43) Pub. Date: Mar. 28, 2024

(54) METHODS FOR MONITORING PROCESSES, PROGRESS, AND WORKER TIME AT A CONSTRUCTION SITE

(71) Applicant: Versatile, Inc., San Francisco, CA (US)

(72) Inventors: Barak Cohen, San Francisco, CA (US); Ran Oren, San Francisco, CA (US); Meirav Oren, San Francisco, CA (US)

(21) Appl. No.: 18/373,862

(22) Filed: Sep. 27, 2023

Related U.S. Application Data
(60) Provisional application No. 63/410,604, filed on Sep. 27, 2022.

(51) Int. Cl. G06Q 10/0633; G06Q 50/08

(52) U.S. Cl. CPC G06Q 10/0633; G06Q 50/08

(57) ABSTRACT

A method includes: accessing a virtual building model defining a constellation of virtual elements, each virtual element representing a building element of a building on a construction site and associated with an installation location of the building element; for a first lift event at a crane, accessing first lift event data; correlating the first lift event with a first building element represented by a first virtual element; in response to correlating the first lift event with the first building element, annotating the first virtual element in the virtual building model with detection of installation of the first building element; identifying a second virtual element, linked to and preceding the first virtual element in the virtual building model; and in response to absence of detection of installation of a second building element prior to installation of the first building element, generating a notification indicating an erroneous installation order.

### CROSS-REFERENCE TO RELATED APPLICATIONS

This application claims the benefit of U.S. Provisional Patent Application No. 63/410,604, filed on 27 Sep. 2022, which is incorporated in its entirety by this reference.

This Application is related to U.S. Pat. No. 10,968,084, filed on 25 Sep. 2020, U.S. patent application Ser. No. 17/163,182 filed on 29 Jan. 2021, and U.S. Pat. No. 11,511,972 filed on 31 May 2022, each of which is incorporated in its entirety by this reference.

### TECHNICAL FIELD

This invention relates generally to the field of construction management and more specifically to a new and useful method for modifying a building schedule for a construction site based on methods for monitoring processes, progress, and worker time at a construction site in the field of construction management.

### BRIEF DESCRIPTION OF THE FIGURES

FIG. 1 is a flowchart representation of a method;

FIG. 2 is a flowchart representation of one variation of the method;

FIG. 3 is a flowchart representation of one variation of the method;

FIG. 4 is a flowchart representation of one variation of the method;

FIGS. 5A and 5B are graphical representations of one variation of the method;

FIG. 6 is a flowchart representation of one variation of the method;

FIG. 7 is a flowchart representation of one variation of the method; and

FIG. 8 is a graphical representation of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

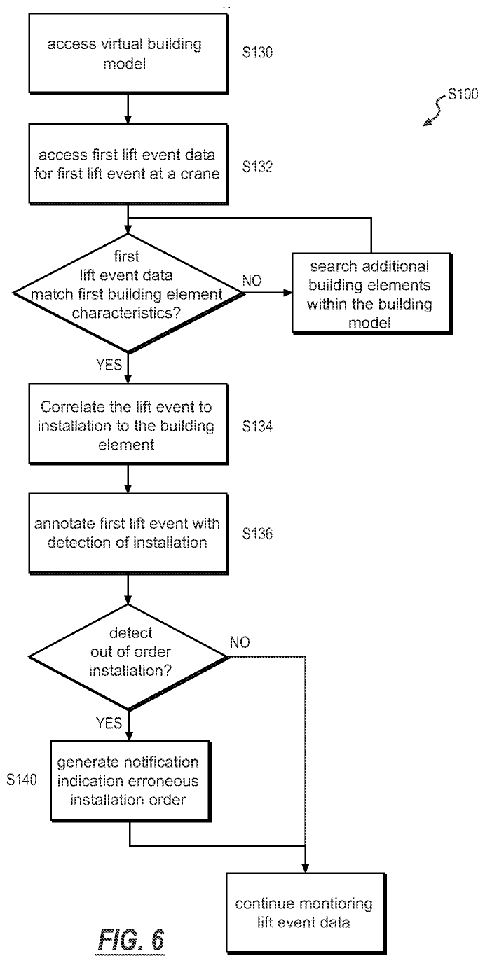

As shown in FIG. 6, a method S100 for monitoring processes and progress at a construction site includes: accessing a virtual building model defining a constellation of virtual elements, each virtual element a) representing a building element of a building on a construction site b) associated with an installation location of the building element, c) linked to a preceding virtual element, in the constellation of virtual elements, representing a preceding building element installed in the building prior to the building element, and d) linked to a succeeding virtual element, in the constellation of virtual elements in Block S130, representing a succeeding building element installed in the building following the building element; for a first lift event at a crane, accessing event characteristics in Block S132; based on the event characteristics of the first lift event, correlating the first lift event with a first building element represented by a first virtual element in the virtual building model in Block S134; in response to correlating the first lift event with the first building element, annotating the first virtual element in the virtual building model with detection of installation of the first building element in Block S136; identifying a second virtual element, in the constellation of virtual elements, linked to and preceding the first virtual element in the virtual building model in Block S138; and, in response to absence of detection of installation of a second building element, associated with the second virtual element, prior to installation of the first building element generating a notification indicating an erroneous installation order of the first building element and transmitting the notification to an operator in Block S140.

### 1.1 Variation: Building Element Grouping

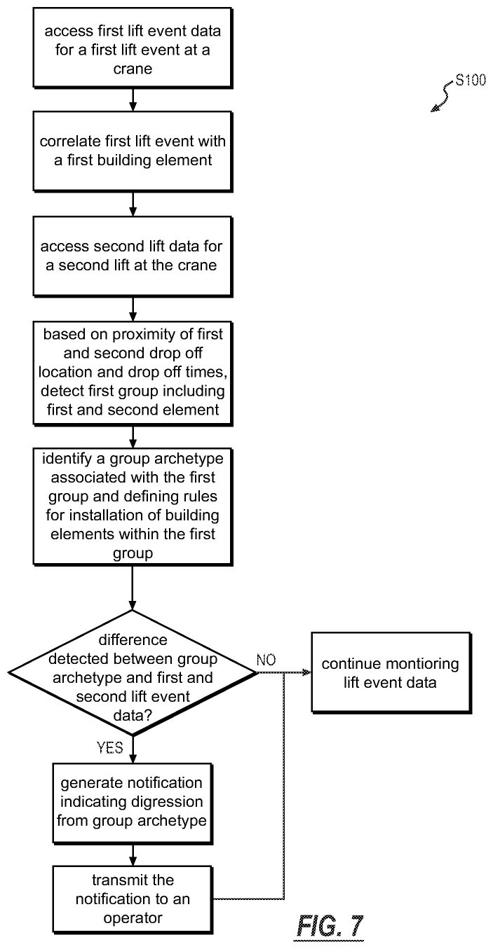

One variation of the method S100, shown in FIG. 7, includes monitoring processes and progress at a construction site by: for a first lift event at a crane during a first time, accessing first lift event data including a) a first pickup location, b) a first element weight, c) a first drop-off location, and d) a first drop-off time; based on the first pickup location and the first element weight, correlating the first lift event with a first building element; for a second lift event at a crane during a second time, accessing a second lift event data including a) a second pickup location, b) a second element weight, c) a second drop-off location, and d) a second drop-off time; based on the second pickup location and the second element weight, correlating the second lift event with a second building element; detecting a group of the first building element and the second building element based on a proximity of the first drop-off location and the second drop-off location and a proximity of the first drop-off time and the second drop-off time; identifying a group archetype from a set of group archetypes associated with the group; and, in response to detection of a difference between the group archetype and the first lift event data and the second lift event data generating a notification indicating a digression from the group archetype and transmitting the notification to an operator.

### 1.2 Variation: Task Completion Tracking and Visualization

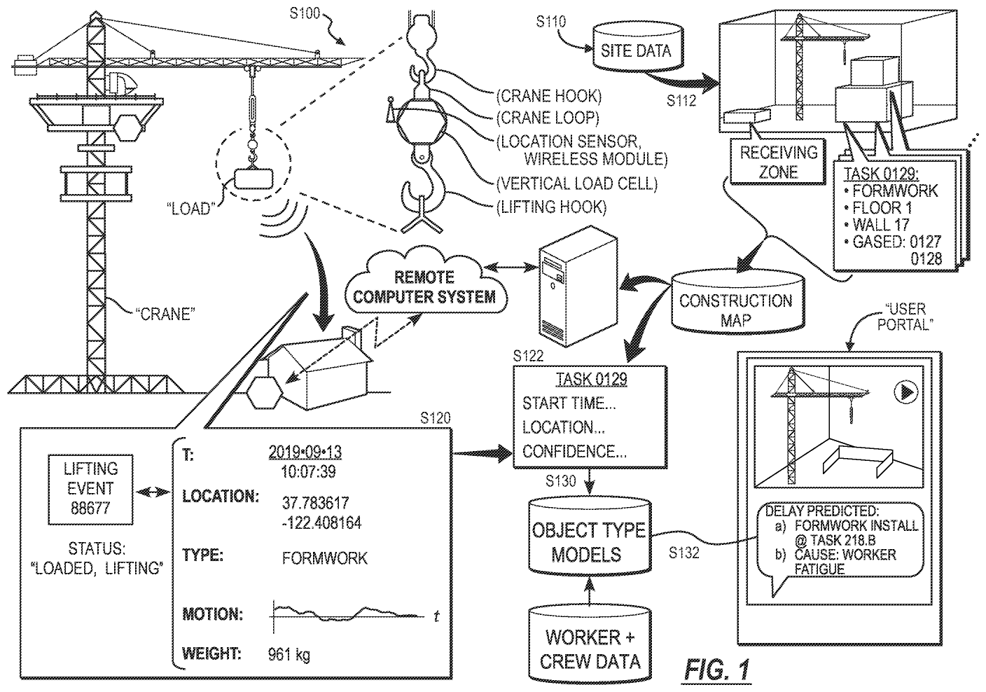

In an additional variation, the method S100 as shown in FIG. 1 includes: accessing a building model, a site plan, and a building schedule for the construction site in Block S110; compiling the building model, the site plan, and the building schedule for the construction site into a construction map containing spatial and temporal representations of construction tasks planned on the construction site in Block S112; accessing a first set of load characteristics detected by a smart hook, arranged on a crane at the construction site, and a first geospatial location of the smart hook during a first lift event at the crane in Block S120; correlating the first lift event with a particular construction task defined in the construction map of the site based on the first set of load characteristics and the first geospatial location in Block S122; tracking completion of construction tasks in the building schedule based on correlation of the first lift event to the particular construction task; and representing characteristics of elements installed on the construction site and actions completed within construction tasks in a corpus of construction task containers for the construction site.

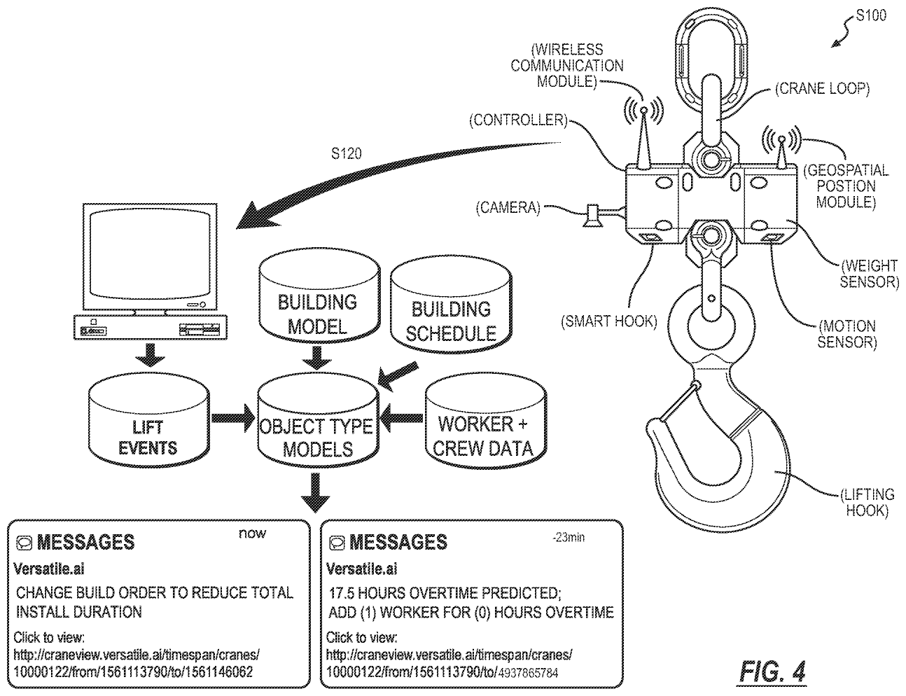

As shown in FIG. 4, the method S100 can further include: aggregating a first set of construction task containers associated with a first set of elements of a first element type and containing historical install durations of the first set of elements, the first set of elements installed on the construction site prior to a first time; based on the first set of construction tasks and characteristics of the first set of elements, training a model to predict install duration of elements of the first element type based on element characteristics and construction task actions at the construction site; and generating a set of predicted install durations of a second set of elements of the first type not installed on the construction site by the first time based on the model and characteristics of the second set of elements.

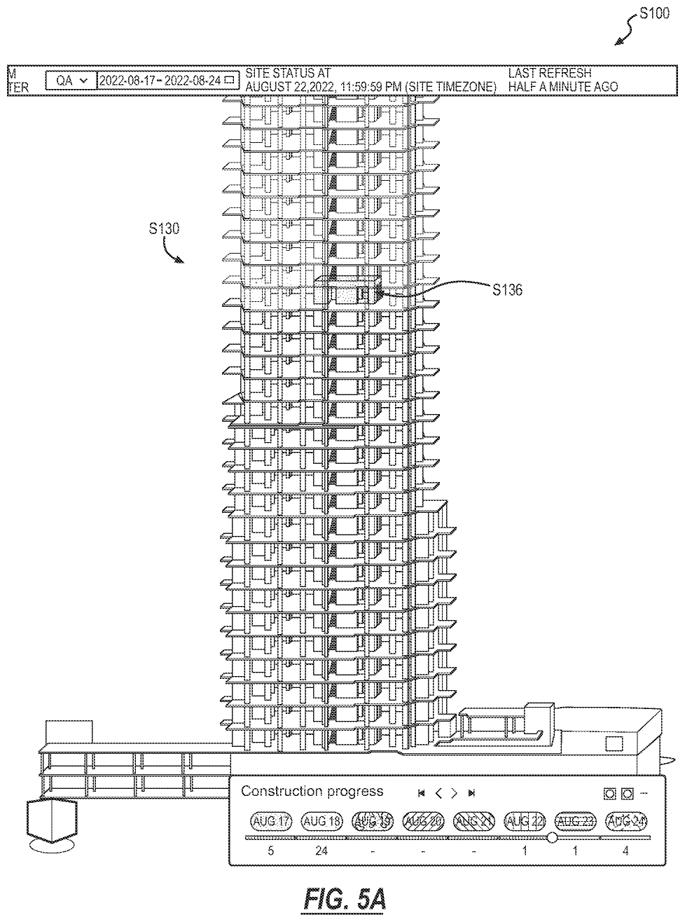

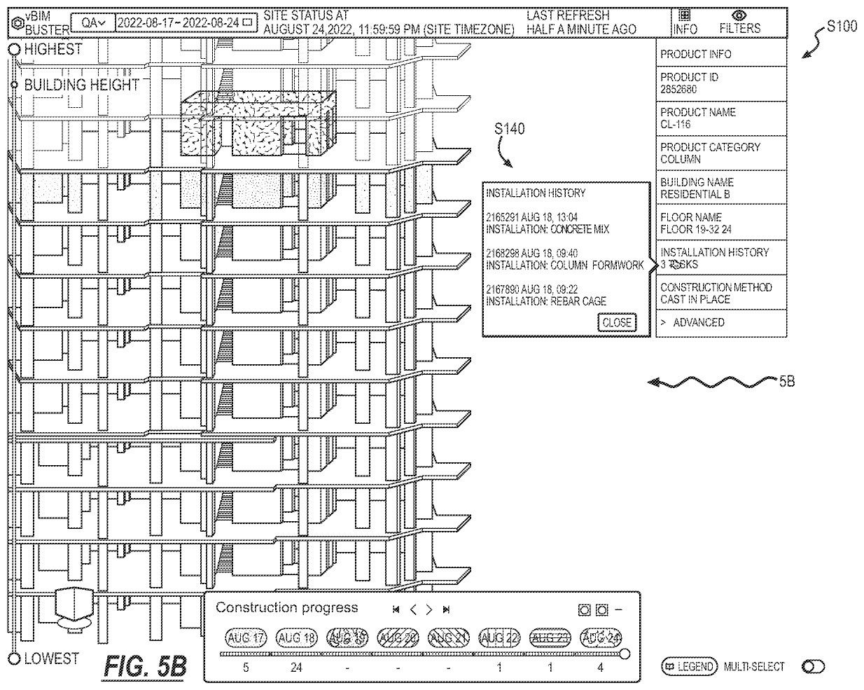

As shown in FIGS. 5A and 5B, the method S100 can further include: rendering a visualization of the first set of elements and the second set of elements within a virtual building model of the construction site; highlighting the first set of elements within the virtual building model according to historical install durations of the first set of elements; and highlighting the second set of elements within the virtual building model according to predicted install durations of the second set of elements.

### 1.3 Variation: Worker Scheduling and Overtime Prediction

One variation of the method S100 shown in FIG. 4 further includes: selecting an incomplete construction task from the building schedule; retrieving a set of characteristics of the construction task and an element prescribed in the construction task; accessing a scheduled quantity of workers assigned to the construction task and a worker schedule associated with the quantity of workers; predicting a nominal install duration of the element based on the model, the set of characteristics, and the scheduled quantity of workers; calculating a set of alternate install durations of the element based on the model, the set of characteristics, and a set of alternative quantities of workers; generating a set of overtime hour predictions for the construction task based on the nominal install duration, the set of alternative install durations, and the worker schedule; presenting the set of overtime hour predictions to a user (e.g., a superintendent of the construction site); and updating the scheduled quantity of workers assigned to the construction task according a selection from the set of overtime hour predictions.

### 2. Applications

Generally, the method S100 can be executed by a computer system: to ingest construction plan data, such as in the form of a building model, a site plan, and/or a building schedule; and to transform these construction plan data into an ordered sequence of construction tasks linked to geospatial locations, materials, material quantities, etc.

During construction at the construction site, the computer system can then execute Blocks of the method S100: to access lift event data (e.g., material type, material quantity, pickup location, drop-off location) from a “smart hook” mounted to a crane operating on the construction site; to correlate these lift event data to a particular building element and/or construction task defined in the construction map; and to track completion of construction tasks in the building schedule.

The computer system can further train a model to predict characteristics of future construction tasks (and component actions therein) based on the model, characteristics of elements that are the target of these construction tasks, and forecast conditions on the construction site, such as including: construction task completion duration (hereinafter “element install duration”); and errors (e.g., injuries, element placement and install errors, element delivery failures).

The computer system can then: isolate characteristics, conditions, and parameters on the construction site that contribute to longer install durations and higher error rates for elements of particular types; and generate prompts to a user (e.g., a superintendent at the construction site) to adjust a building schedule, construction task order, and/or a contracted worker quantity within a trade, etc. to reduce frequency of these characteristics, conditions, and parameters at the construction site.

Additionally or alternatively, the computer system can automatically update the building schedule, construction task order, and/or a contracted worker quantity within a trade, etc. to reduce frequency of these characteristics, conditions, and parameters at the construction site.

Furthermore, the computer system can generate a visualization of the construction site (or a building on the construction site more specifically) that depicts both historical characteristics (e.g., detected install durations) of elements already installed and predicted characteristics (e.g., predicted install durations) of elements not yet installed at the construction site, such as: elements of a particular element type (e.g., steel girders, formwork, rebar, cast-in-place concrete, precast concrete structures); and/or groups of elements of multiple types that form common or repeated structures throughout the construction site. The computer system can then serve this visualization to the user to enable the user to quickly perceive past and predicted progress related to installation of elements or groups of elements of particular element types at the construction site.

Furthermore, the computer system can execute Blocks of the method S100 to detect an error within a construction task. In one example, the computer system executes the method S100 to: correlate a first lift event with a first building element; correlate a second lift event with a second building element scheduled to be installed before the first building element; detect an erroneous installation order error; annotate the building model to represent the error; and generate a notification indicating the error to an operator of the computer system. The computer system further automatically modifies the building model based on a detected error such as to update a predicted construction duration or re-order a series of future tasks for greater construction efficiency.

Therefore, the computer system can execute Blocks of the method S100 to: correlate lift events by a crane to installation of a particular building element; detect errors based on the lift event data of a lift event; generate notifications to an operator of the system to mediate the errors; render a virtual building model annotated with a detected error; and update the building model with construction predictions based on historical lift event data.

The method S100 is described herein as executed by a remote computer system, such as a computer network or remote machine. However, Blocks of the method S100 can additionally or alternatively be executed by the smart hook, by a local computer, and/or by a user's personal computing device, etc.

### 3. Site Data

Block S110 of the method S100 recites accessing a building model, a site plan, and a building schedule for the construction site. Generally, in Block S1io, the computer system can interface with a user (e.g., a site manager, a supervisor)—such as through a user portal within a native application or within a web browser executing on a computing device—to access a 3D electronic building model (e.g., a Building Information Modeling (or “BIM”) model), an electronic site plan, and/or a building schedule for the construction site.

For example, the 3D electronic building model can define a volumetric representation of a building (or other structure) on the construction site, such as including discrete volumetric representations of: rebar elements; cast-in-place concrete elements; precast elements; structural steel elements; exterior façade elements; wall studs; interior walls surfaces; glazing elements; plumbing elements; electrical and communications elements; and/or HVAC elements; etc.

In one implementation, the method S100 includes accessing a building model (e.g., a virtual building model) defining a constellation (e.g., a set, an array) of virtual elements. Each virtual element of the building model: represents a building element of a building on a construction site; is associated with an installation location of the building element; links to a preceding virtual element, in the constellation of virtual elements, representing a preceding building element installed in the building prior to the building element; and/or links to a succeeding virtual element, in the constellation of virtual elements, representing a succeeding building element installed in the building following the building element.

For example, a first building element can define one or more rebar elements for support of a concrete structure, and the building model includes a first virtual element representing the first building element. A second building element can define a set of framework for shaping a concrete structure, and the building model includes a second virtual element representing the first building element. In this example, building model links the second virtual element to the first virtual element, and installation of the second virtual element (defining the framework) precedes installation of the first virtual element (defining the rebar). The building model can additionally include a third virtual element representing a third building element defining a volume of concrete to be poured. The third virtual element links to the first virtual element and installation of the volume of concrete succeeds installation of the rebar.

In this implementation, the building model includes: a volumetric representation of the building (e.g., a three-dimensional virtual representation, a CAD model) on the construction site including virtual representations of each building element as a virtual element; a site plan; and a building schedule. The site plan can include: a layout of the construction site; building element pickup, drop-off, and installation locations; a crane location; and a crane access area. The building schedule can include: a set of construction tasks, each construction task defining a target task duration; and a target construction duration.

Therefore, the building model can include a set of virtual elements representing a set of real-world building elements wherein each virtual element links to a preceding element and to a succeeding element based on a target installation order of the building elements. The building model can further include the site plan and building schedule to render a mapping of the construction site and measure progress of construction based on lift events at the construction site.

In this example, the site plan can define a 2D or 3D representation of the construction site, such as including georeferenced perimeters or locations for: the building (or other structure); drive- and walkways; exterior landscaping and lighting elements; material staging zones (e.g., formwork, scaffolding, and rebar storage areas); material receiving zones; material processing areas (e.g., an onsite concrete mixing area); and/or a crane tower location and crane access scope.

Furthermore, in this example, the building schedule can specify: a set of construction tasks (e.g., installing scaffolding; installing rebar; pouring concrete); a set of construction cycles (e.g., construction of a structural elements of a building floor), each containing a set of construction tasks; and/or a target start time, completion time, and/or duration of each construction task or construction cycle.

### 4. Construction Map

Block S112 of the method S100 recites compiling the building model, the site plan, and the building schedule into a construction map containing spatial and temporal representations of construction tasks planned on the construction site. Generally, in Block S112, the computer system can fuse the building model, the site plan, and the building schedule for the construction site into an ordered sequence of construction tasks.

In one implementation, the computer system can fuse these construction data into an ordered sequence of construction tasks, wherein each construction task is associated with: a construction task type (e.g., receiving and staging, material delivery for installation, tool delivery for task support, tool retrieval, and site removal); a material (or tool); a material (or tool) quantity; rigging geolocation on the construction site; an unrigging geolocation at the construction site; a georeferenced building volume for (permanent or temporary) installation of the material (or tool); a target start time, conclusion time, and/or duration of the construction task; a link to a preceding construction task(s) requiring completion and/or inspection prior to the construction task; and/or a link to a subsequent construction task(s) not permitted prior to completion or inspection of the construction task.

For example, the computer system can spatially align the building model to the site plan. The computer system can then: select a first construction task in the construction schedule; initialize a new construction task element for this construction task; read a material (or tool) from this construction task and a location description from the construction task; query the site plan for an unloading geolocation that matches this location description and for a rigging location associate with storage or staging of this material; and then write this material (or tool), this rigging geolocation, and this unloading geolocation to the construction task element. Furthermore, the computer system can: scan the building model for a first (or lowest) discrete volume of this material; write a georeferenced boundary around this discrete volume to the construction task element; and write a start time, conclusion time, and/or duration—extracted from this construction task in the schedule—to this construction task element. The computer system can then repeat this process for each other construction task represented in the schedule. Thus, in this implementation, the computer system can implement present rules for fusing these site data into a set of construction tasks for the construction site.

In another implementation, the computer system implements natural language processing and artificial intelligence to interpret and transform these site data into a set of construction task elements for the construction site.

Additionally or alternatively, the computer system can interface with the user—via the user portal—to manually define links between elements in the building model, the site plan, and the building schedule. In this implementation, the computer system can then compile linked elements from these site data into a set of discrete, ordered, and gated construction tasks for the construction site.

However, the computer system can implement any other method or technique to fuse the site data into a set of construction tasks for the construction site in Block S112. The computer system can then store this set of construction tasks in a computer system for the construction site.

### 6. Smart Hook

As described above, the computer system can interface with a smart hook—installed on a lift hook of a crane—to receive lift event data as materials and tools are rigged to the crane at pickup locations on the construction site and unloaded from the crane at other drop-off locations on the construction site.

In one implementation shown in FIG. 4, the smart hook (or “hook adapter”) includes: a crane loop (e.g., a “welded link,” “oval ring,” or shackle) configured to transiently (i.e., temporarily, removably) install on a crane hook of a crane; a lifting hook arranged below the crane hook and configured to couple to a load; a weight sensor (e.g., a load cell) interposed between the crane loop and the lifting hook and configured to output a signal representing a tensile force between the crane loop and the lifting hook; a motion sensor (e.g., a gyroscope, accelerometer, magnetometer, and/or IMU) configured to output signals representing accelerations and/or angular velocities of the smart hook; an optical sensor (e.g., a color camera, a depth sensor, a 3D camera, and/or an infrared camera) defining a field of view facing downward below the lifting hook; a geospatial position module configured to output its geospatial location; an altimeter configured to output a signal representative of the height of the smart hook; a controller configured to sample the weight sensor, the motion sensor, the optical sensor, and the geospatial position module and/or to transform these signals into lift event records according to the method S100; and a wireless communication module configured to transmit raw data output by the weight sensor, the motion sensor, the optical sensor, and the geospatial position module and/or to transmit lift event records to a computer system. (The smart hook can also include other sensors, such as an RFID reader, a humidity sensor, an infrared camera, an ultrasonic depth sensor, and/or a scanning LIDAR sensor.)

Generally, the smart hook can be rapidly deployed to cranes of various sizes and lifting capacities by placing the crane loop over a crane hook with the lifting hook hanging below the crane loop. A load (e.g., construction materials, construction equipment, scaffolding) may then be attached to the lifting hook, which transfers the weight of the load into the crane loop, which transfers the weight of the load and the smart hook into the crane hook thus carried by the crane. In particular, the smart hook: is configured for rapid deployment to a crane without modification to structural elements of the crane; and includes sensors that enable tracking of load weight, motion, and 3D position (e.g., geospatial location and altitude) directly at the lifting hook carrying the load (i.e., rather than remotely from the load). Furthermore, because the smart hook is self-contained and is configured to install onto and hang below a crane hook integrated into a crane, the smart hook can be rapidly installed and removed from a crane hook by simply lifting the crane loop onto and off of a crane hook. Therefore, the smart hook may follow a general contractor or site manager to various job sites over time in order to supply load-related insights to the general contractor or site manager over time.

Furthermore, the smart hook and/or the computer system can implement template matching, deep learning, and/or artificial intelligence techniques to distinguish different types of elements lifted by the smart hook, such as including: a long steel beam based on a linear increase in load measured by the load cell in the smart hook as the beam is lifted and low-amplitude resonant vibrations between 100 Hz and 1000 Hz measured by a motion sensor (e.g., an IMU, an accelerometer) in the smart hook once the beam is fully lifted; a bundle of loose rebar based on a continuous but non-linear increase in load measured by the load cell as the bundle is lifted and moderate-amplitude resonant vibrations between 0.1 Hz and 5 Hz measured by the motion sensor once the bundle is fully lifted; and a loaded concrete mixer based on high-amplitude oscillations between 0.1 Hz and 2 Hz (i.e., from wet concrete “sloshing” inside a drum in the concrete mixer) and lower-amplitude, higher-frequency machine vibrations (i.e., from a motor rotating the drum) measured by the motion sensor once the concrete mixer is fully lifted. In these examples, the smart hook (or the computer system) can generate a lifting event for each of these loads. For each of these lifting events, the smart hook can also store: a peak weight measured by the load cell during the lifting event; geospatial locations output by the geospatial position sensor when the load was first detected and then unloaded; and altitudes output by an altimeter in the smart hook when the load was first detected and then unloaded. Furthermore, when the concrete mixer is then unloaded, lifted away from the drop-off location, and returned to the pickup location, the smart hook (or the computer system) can record a change in weight of the concrete mixer as an amount of concrete delivered to this drop-off location and write this amount of concrete to the corresponding lifting event record.

### 7. Lift Event Data

Block S120 of the method S100 recites accessing a first set of load characteristics detected by a smart hook, arranged on a crane at the construction site, and a first geospatial location of the smart hook during a first lift event at the crane.

In one implementation, in Block S120, the computer system receives a stream of lift event data from the smart hook. For example, the computer system can receive lift event data from the smart hook at a rate of 1 Hz, including: the geospatial location of the smart hook; a weight of a load connected to the smart hook; images captured by a camera integrated into the smart hook; and/or a material type (and/or confidence scores for various material types) of a load (or “element”)—connected to the smart hook—predicted locally by the smart hook based on these image, motion, and/or load data thus collected by the smart hook. Alternatively, the computer system can: receive raw geolocation, image, motion, and/or load data from the smart hook; and predict a material type of a load rigged to the smart hook during a current lift event based on these data.

### 7.1 Element Models

In one implementation, during operation, the smart hook accesses element models for identifying types of element flowing through the construction site, such as in the form of: weight ranges and loading/unloading profiles (or “template loading curves”) for distinguishing element types in timeseries load data captured by the weight sensor; natural frequency ranges or natural frequency profiles (or “template vibration curves”) for distinguishing element types in timeseries motion data (e.g., acceleration, angular velocity data) captured by the motion sensor; and/or template images, color models, and/or symbol models for identifying element types in images recorded by the optical sensor based on features extracted from these images.

Additionally or alternatively, these element models can specify physical element characteristics (e.g., common dimensions, color) and/or operational knowledge (e.g., rigging methods, unloading and installation methods). The smart hook can thus identify an element carried by the smart hook further based on these element models and other features extracted from images and/or motion data captured by the smart hook during a lift event.

Additionally or alternatively, the smart hook can implement neural networks or other models trained to distinguish types of elements loaded onto the smart hook based on timeseries load data, timeseries motion data, and/or photographic images.

### 7.2 New Lift Event

While in an active state, the smart hook can: sample the weight sensor; convert outputs of the weight sensor into weight magnitudes; and write these timestamped weight magnitudes—along with motion data read from motion sensors, geospatial location data, and altitude—to a local rolling buffer (e.g., a one-minute rolling buffer). When the weight magnitude measured by the weight sensor exceeds a stored tare value by more than a threshold weight (e.g., 50 kilograms), the smart hook can: detect a new lift event at the smart hook; initialize a new lift event record for this new lift event; and write contents of the buffer (e.g., raw sensor data) to the new lift event record. The smart hook can then continue to sample the weight sensor, the motion sensor, the geospatial position module, and the altimeter, etc. (e.g., at the same or greater sampling rates) and write these data to new lift event record.

Upon detecting a new lift event, the smart hook can also transmit a “loading” status to the computer system to indicate to the computer system that the smart hook is currently being loaded with an element. The computer system can then update a status of the smart hook in the manager portal to reflect this new status of the smart hook, thereby enabling the site manager or other operator viewing the manager portal to immediately see a live change in the status of the smart hook.

### 7.3 Element Type Identification

Generally, the smart hook can automatically identify a type of element (and other characteristics of this element) carried by the smart hook based on timeseries data collected by weight sensor and/or the motion sensor, etc. during a lift event. For example, the smart hook can derive a “fingerprint” of a load in each of multiple sensor modalities, predict the identity of the load in this different sensor modalities based on data collected by these sensors, and then fuse these predictions to identify a type of the load with greater confidence, as shown in FIGS. 1, 2, and 3.

### 7.3.1 Loading Profile

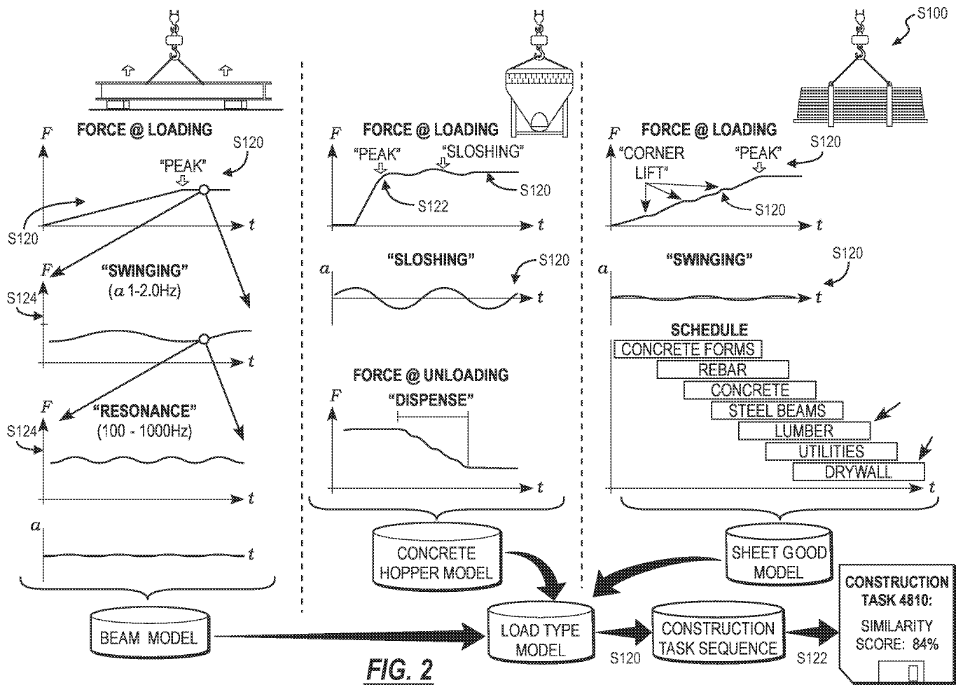

In one implementation shown in FIG. 2, the smart hook: records a timeseries of weight values read from the weight sensor following the start of the new lift event; calculates a derivative of this timeseries of weight values; and isolates a segment of this timeseries exhibiting a null or near-null derivative and corresponding to a “loading period.” The smart hook then extracts a loading profile (e.g., a curve geometry, a rate of change) from the timeseries of weight values recorded over this loading period and matches this loading profile to a template loading profile for a particular element type.

### 7.3.2 Motion Profile

The smart hook can similarly: monitor lateral and vertical timeseries acceleration signals output by a multi-axis accelerometer (e.g., within an inertial measurement unit) in the smart hook; and identify the element based on these timeseries acceleration values. For example, the smart hook can identify a load carried by the smart hook as a concrete hopper in response to detecting a low-frequency, decaying signal component in a signal—output by a horizontal axis in an accelerometer integrated into the smart hook—which may result from concrete sloshing laterally inside the concrete hopper, as shown in FIG. 2.

Additionally or alternatively, the smart hook can similarly: monitor angular velocity signals output by a multi-axis gyroscope (e.g., within the inertial measurement unit) in the smart hook; and identify the element based on these timeseries angular velocity values. For example, because longer elements may angularly accelerate at slower rates than shorter elements of the same mass, the smart hook can: calculate a confidence score that an element carried by the smart hook is an elongated steel beam inversely proportional to a change in yaw rate detected by the multi-axis gyroscope during the lift event; and calculate a confidence score that the element is a stack of sheet materials proportional to this change in yaw rate.

### 7.3.3 Weight

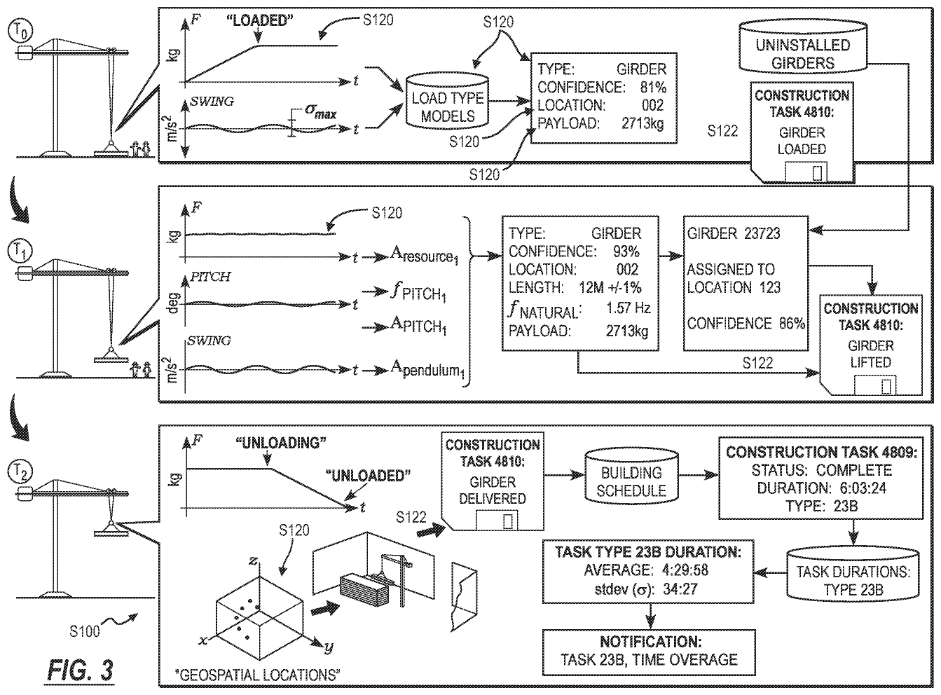

In another implementation shown in FIGS. 2 and 3, the smart hook stores common weight ranges for elements of different types (e.g., full or empty concrete hoppers, steel beams, concrete forms, full stacks of sheet goods, rebar bundles), such as common weight ranges for many construction projects or for the particular construction site currently occupied by the smart hook. The smart hook can then: derive a payload size (or “weight”) of the element from load data captured by the weight sensor in; and calculate a confidence score that an element currently carried by the smart hook is of a particular element type based on proximity of this payload size to a weight range associated with this particular element type.

### 7.3.4 Location

In yet another implementation, the smart hook stores: last known geospatial locations and altitudes of elements of known types at the construction site; geospatial locations and altitudes of staging areas for particular element types at the construction site; and/or geospatial locations and altitudes of drop-off (or “delivery”) locations for particular element types at the construction site, such as a function of date, week, or project stage at the construction site. The smart hook can then calculate a confidence score that an element currently carried by the smart hook is of a particular element type based on proximity of the geospatial location of the smart hook when the element was loaded to a last known location of elements of this type and/or to an assigned staging area of elements of this type. Similarly, as the element is unloaded from the smart hook at the end of a lift event, the smart hook can calculate a confidence score that an element currently carried by the smart hook is of a particular element type based on proximity of the geospatial location of the smart hook when the element was unloaded to a drop-off location assigned to elements of this type.

The smart hook can also calculate or refine a confidence score that an element currently carried by the smart hook is of a particular element type based on proximity of the current time to a scheduled lift event designating this element type.

### 7.3.5 Images

In another implementation, the smart hook implements element detection, element recognition, optical characteristic recognition, template matching, and/or other computer vision techniques to identify the type of element loaded onto the smart hook based on features extracted from an image captured by the optical sensor.

For example, in response to detecting an increase in load—from a tare value carried by the smart hook, the smart hook can: detect a new lift event; and capture a photographic image from a downward-facing camera integrated into the smart hook. The smart hook can then pass this photographic image into a neural network (e.g., a deep convolutional network for element detection, a fully convolutional network for semantic segmentation) to: extract features from a foreground in the photographic image; and identify the type of the element based on these features. Alternatively, after identifying the type of the element based on loading and motion data captured during this lift event, the smart hook can verify the element type thus identified based on this photographic image (e.g., based on features extracted from the photographic image).

In this implementation, the smart hook can also interpret pitch, roll, and/or yaw orientations of the element—relative to the smart hook—based on features detected in a photographic image. By repeating this process while the element is loaded onto the smart hook, the smart hook can track the pitch, roll, and/or yaw orientations of the element—relative to the smart hook—throughout this lift event in near real-time based directly on visual features extracted from images of the element hanging below the smart hook.

The smart hook can additionally or alternatively include other types of optical sensors. For example, the smart hook can include a thermographic (or infrared) camera and can distinguish between metal (e.g., rebar, steel girders), wood (e.g., formwork), concrete, and other materials of elements loaded onto the smart hook based on thermal signatures extracted from regions of thermographic images depicting these elements carried by the smart hook. In a similar example, the smart hook can include a hyperspectral or multispectral camera and can distinguish between metal, wood, concrete, and other materials of elements loaded onto the smart hook based on spectral signatures extracted from regions of hyperspectral or multispectral images depicting these elements carried by the smart hook.

### 7.3.6 Fusion

The smart hook can then calculate a confidence score that an element currently loaded onto the smart hook is of a particular element type based on data collected by sensors integrated into the smart hook, the smart hook can aggregate these confidence scores for various element types across multiple sensor modalities into one prediction of the type of the element, as shown in FIGS. 1, 2, and 3.

### 7.3.6.1 Voting

In one implementation, the smart hook can implement a voting architecture, decision tree, linear regression, or any other structure to fuse or aggregate predictions for the type of element—based on sensor data of different types—into one predicted identity of the element.

In this implementation shown in FIGS. 2 and 3, the smart hook can: derive a lifting profile—representing transition of the weight of the element onto the smart hook from a first time to a second time spanning a loading period—from a timeseries of load values captured by the smart hook; detect a peak load, in the timeseries of load values, representing complete loading of the element onto the smart hook at the second time; and store this peak load as the weight of the element. The smart hook can then: derive a natural frequency of the element from a second timeseries of load values captured by the smart hook over a traversal period following the second time (i.e., once the element is fully loaded onto the smart hook); and derive a pitch frequency of the element (e.g., a frequency than the element pitches, rolls, or “sloshes” while suspended from the smart hook) from a second timeseries of motion values (and/or from the second timeseries of load values) captured by the smart hook during the traversal period.

The smart hook can then: identify a set of element types allocated to the construction site generally or designated for relocation by the crane during a current work period (e.g., the current day, a current shift); retrieve element profiles for these element types; calculate a set of pitch frequency similarity scores for the element, wherein each pitch frequency similarity score in the set represents proximity of the pitch frequency of the element to a pitch frequency range of an element type in this set of element types; calculate a set of natural frequency similarity scores for the element, wherein each natural frequency similarity score in the set represents proximity of the natural frequency of the element to a natural frequency range of an element type in this set of element types; calculate a set of weight similarity scores for the element, wherein each weight similarity score in the set represents proximity of the weight of the element to a range of weight of an element type in this set of element types; calculate a set of loading similarity scores for the element, wherein each loading similarity score in the set represents proximity of the slope and an oscillation characteristic of the loading profile of the element to ranges of slopes and oscillation characteristics of an element type in this set of element types; and/or calculate a set of pickup location similarity scores for the element, wherein each pickup location similarity score in the set represents proximity of the geospatial location of the smart hook when the element was loaded onto the smart hook to a last known location of an element type, in this set of element types, on the construction site; etc.

The smart hook can then identify the element as a unit of a particular element type based on a combination of the set of pitch frequency similarity scores, the set of natural frequency similarity scores, etc. For example, for a first element in the set of elements allocated to the construction site, the computer system can: calculate a combination (e.g., a linear combination, a weighted combination) of the pitch frequency similarity score, the natural frequency similarity score, the weight similarity score, the loading similarity score, and/or the pickup location similarity score between the element and the first element type; and then store this resulting combination as a confidence score that the element is a unit of the first element type. The smart hook can then repeat this process for each other element type in the set.

Subsequently, the smart hook can identify a particular element type associated with a highest confidence score in this set. If the confidence score for the particular element type exceeds a minimum confidence score, the smart hook can confirm identification of the element as a unit of this particular element type. Conversely, if the confidence score for the particular element type is less than the minimum confidence score, the smart hook can: provisionally identify the element as a unit of this particular element type; mark the element as provisionally identified in subsequent lift event records generated by the smart hook (or the computer system) for this element; and continue to refine and validate identification of the element based on subsequent data captured by the smart hook during this lift event, as described below.

Upon identifying the type of the element, such as with greater than a threshold confidence, the smart hook can transmit an identifier for this element type to the computer system, and the computer system can update the manager portal to indicate that an element of this type is currently loaded onto the smart hook. The smart hook can also write the identifier of this element type to the current lift event record.

### 7.3.6.2 Artificial Intelligence and Deep Learning

Additionally or alternatively, the smart hook can implement artificial intelligence, machine learning, and/or deep learning techniques: to ingest timeseries load, motion, and/or geospatial location data, etc. recorded as the element is loaded onto and carried by the smart hook; and to output a confidence score or rank for a type of the element carried by the smart hook. The smart hook can then execute methods and techniques described herein based on a highest-confidence element type thus identified during a lift event by the smart hook.

### 7.3.6.3 Examples

In one example, the smart hook can: capture a first timeseries of load values output by a weight sensor, coupled to the smart hook, during a first time period; capture a first geospatial location of the smart hook during loading of an element onto the smart hook during the first time period; derive a lifting profile of the element at the first geospatial location from the first timeseries of load values; derive a weight of the element from the first timeseries of load values; and identify a type of the element carried by the smart hook during the first time period based on the lifting profile.

In a similar example, the smart hook can: capture a first timeseries of load values output by a weight sensor, coupled to the smart hook, during a first time period; capture a first timeseries of motion values output by a motion sensor coupled to the smart hook; capture a first geospatial location of the smart hook during the first time period; derive a lifting profile from the first timeseries of load values; derive a first oscillation characteristic from the first timeseries of motion values; and identify a type of an element, carried by the smart hook during the first time period, based on the lifting profile and the first oscillation characteristic. In particular, in this example, the smart hook can: derive a pitch frequency of the element from the first timeseries of motion values; derive a natural frequency of the element from the first timeseries of motion values; calculate a set of pitch frequency similarity scores for the element, each pitch frequency similarity score in the set of pitch frequency similarity scores representing proximity of the pitch frequency of the element to a pitch frequency range of an element type in a set of element types; calculate a set of natural frequency similarity scores for the element, each natural frequency similarity score in the set of natural frequency similarity scores representing proximity of the natural frequency of the element to a natural frequency range of an element type in the set of element types; and identify the element as a unit of a first element type based on a combination of the set of pitch frequency similarity scores and the set of natural frequency similarity scores.

### 7.3.7 Lift Event Data

In one implementation, the computer system generates a set of lift event data including: a pickup location defining a first geospatial coordinate at which the building element is loaded onto the crane; a drop-off location defining a second geospatial coordinate at which the building element is unloaded from the crane; and an installation location defining a third geospatial coordinate at which the building element is installed. In one example, the drop-off location and the installation location occupy the same geospatial coordinate. For example, a heavy building element such as a prefabricated concrete pillar may not be moveable except by the crane. Therefore, the building element is unloaded from the crane precisely at the installation location. In another example, a building element can define a set of rebar for installation. In this example, the drop-off location can define a location near (e.g., within 1-10 yards of) the installation location. A crew of worker can unload the set of rebar from the crane at the drop-off location and disseminate each rebar in the set of rebar to an individual installation location proximal the drop-off location.

The computer system generates each of the pickup location, drop-off location, and installation location by defining a three-dimensional geolocation including a latitude, longitude, and altitude. Therefore, in one implementation, the computer system correlates the first lift event to the first building element represented by the first virtual element by: detecting, from the first lift event data, a drop-off location of the first building element defining a three-dimensional geolocation; and detecting the drop-off location within a threshold distance of the installation location of the first building element.

For example, the computer system executes the method S100 to access the virtual building model to: access the first virtual element including a steel girder; and access an installation location of the first element defining a geolocation associated with a west face of a third floor of the building. In this example, correlating the first lift event to the first building element represented by the first virtual element includes: detecting latitude and longitude of a hook of the crane within a threshold distance of the west face of the building during an unloading phase of the first lift event; and detecting an altitude of the hook of the crane within a threshold range of the third floor of the building during the unloading phase of the first lift event.

Thus, the computer system defines a set of lift event data including pickup, drop-off, and installation locations. Therefore, the computer system can correlate a lift event to a building element by matching an expected pickup, drop-off, and installation location for a virtual element to an actual pickup, drop-off, and installation location of a building element during a lift event.

### 7.4 Load Verification and Element Type Refinement

Furthermore, the smart hook can repeat the foregoing methods and techniques to verify or refine the type of element thus identified in based on additional data collected by the smart hook after the element is loaded onto the smart hook and until the element is subsequently unloaded, as shown in FIG. 3. In particular, the smart hook can calculate increasing confidence scores for the identity of the element over time based on additional load, motion, and geospatial location data collected by the smart hook between a time the element is loaded onto the smart hook and a time that the element is unloaded from the smart hook.

In one example, ends of a long beam may be guided manually with rigging or tow lines when lifted at a pickup location and when lowered at a drop-off location. Manipulation of the beam via the rigging lines may yield acyclic vertical loads and acyclic angular velocities about the pitch and yaw axes of the steel beam with long ramp times and decay times. Therefore, if the smart hook detects acyclic load changes and acyclic angular velocities with long ramp times following detection of a payload size during a lift event, the smart hook can calculate a greater confidence that the element is a long beam.

In another example, when a long beam is lowered onto the ground or other structure below, one end of the beam may contact the ground first, thereby transferring some weight from this first end of the beam into the ground. As the length of the beam makes contact with the ground as the beam is further lowered, the weight of the beam carried by the smart hook may decrease continuously (e.g., approximately linearly). The load profile of the signal output by the weight sensor as a beam is unloaded from the smart hook may therefore be characterized by a substantially continuous downward slope from payload size to tare. Conversely, when a stack of sheet goods is lowered onto the ground or other structure, one corner of the stack may contact the ground first, thereby transferring some weight from this first corner of the stack into the ground. As the stack is further lowered, one edge of the stack may come into contact with the ground. As the stack is lowered even further and then fully unloaded from the smart hook, the opposing edge of the stack may come into contact with the ground. The load profile of the signal output by the weight sensor as a stack of sheet goods is unloaded from the smart hook may therefore be characterized by two or more discontinuities or inflections, which may differ from a load profile of a signal output by the weight sensor as a beam is unloaded from the smart hook, which may be characterized by one discontinuity or inflection.

In yet another example, a concrete hopper may be left attached and (partially) supported by the smart hook upon arrival at a drop-off location. Concrete may then be dispensed from the concrete hopper, and the concrete hopper may then be hoisted and moved away from this drop-off location by the smart hook. Therefore, once the concrete hopper is lowered at its drop-off location, the load measured by the weight sensor may decrease (slowly) from an initial payload size but may not reach the stored tare value before the measured load again increases as the concrete hopper is lifted. The smart hook can therefore identify an element as a concrete hopper if the element is delivered to a drop-off location at a first payload size and then removed from the drop-off location at a second, lower payload size without detecting fully unloading the element from the smart hook.

However, the smart hook can implement any other method or technique to identify and verify a type of element loaded onto the smart hook. Furthermore, upon refining an element type identification of an element carried by the smart hook, the smart hook can transmit an update of the detected element type to the computer system, and the computer system can update the manager portal to reflect this element type revision accordingly. The smart hook can also rewrite the identifier of this element type to the current lift event record.

### 7.4.1 Element Type Prediction Refinement Based on Load Status

In a similar implementation, the smart hook implements the foregoing methods and techniques to predict the type of the element loaded onto the smart hook based on an initial set of data captured by the smart hook at the beginning of the lift event and refines this prediction based on additional data captured by the smart hook as the element is fully loaded onto the smart hook, lifted by the crane, moved laterally, lowered, and unloaded from the smart hook.

In particular, the smart hook can: record its geospatial location and an initial timeseries of load data as the element is loaded onto the smart hook during a loading period; and calculate an initial prediction of the type of the element based on this pickup location and a loading profile derived from these timeseries load data. The smart hook can then: record timeseries load and motion data during a transfer period as the crane moves the smart hook and the element from the pickup location to a drop-off location; and refine the predicted type of the element based on load and motion characteristics, such as natural frequency of the element, pitching frequency and amplitude of the element, and/or “sloshing” frequency and amplitude of the element. Furthermore, the smart hook can: record its geospatial location and a final timeseries of load data as the element is unloaded onto the smart hook during an unloaded period; and further refine the predicted type of the element based on this drop-off location and an unloading profile derived from these timeseries load data.

### 7.5 Load Status

The computer system (or the smart hook) can also derive other characteristics of this lift event. In one implementation, the computer system derives a status of a load rigged on the smart hook based on: a geospatial location of the smart hook when the load is first rigged to the smart hook (i.e., a “pickup location” of the load); and material receiving, material staging, material preparation, building, and other zones defined in the site map. For example, in response to a lift event specifying a pickup location within a material loading zone defined in the site map, the computer system can automatically label this material as “inbound” to the construction site. In another example, in response to a lift event specifying a pickup location within a material staging zone defined in the site map, the computer system can automatically label this material as “install-bound” or otherwise preparing for delivery to its final location. In yet another example, in response to a lift event associated with a “concrete” material and specifying a pickup location within a concrete preparation area or a concrete truck receiving zone defined in the site map, the computer system can automatically label this material as “preparing for concrete pour” at the construction site. In another example, in response to a lift event associated with formwork and specifying a pickup location within a formwork staging zone defined in the site map, the computer system can automatically label this formwork as “install-bound”; conversely in response to a lift event associated with formwork and specifying a pickup location within or near a perimeter of the building defined in the site map, the computer system can automatically label this formwork as “stripped.”

In a similar implementation, while the smart hook carries an element, the smart hook can also identify and broadcast its status to the computer system for publication to the manager portal. For example, as the output of the weight sensor indicates that the load carried by the smart hook is increasing at the start of a new lift event, the smart hook can transmit a “loading” status indicator to the computer system. Once the output of the weight sensor indicates that the load carried by the smart hook is consistent and sufficiently intransient, and as the altimeter indicates that the altitude of the smart hook is increasing, the smart hook can: store the current payload size read by the weight sensor as a weight of the element in the current lift event record; and transmit this weight and a “loaded, lifting” status indicator to the computer system for publication to the manager portal. If the output of the weight sensor indicates that the load carried by the smart hook is sufficiently intransient and greater than the stored tare value and if outputs of the altimeter and geospatial position module are sufficiently intransient, the smart hook can transmit a “loaded, static” status indicator to the computer system for publication to the manager portal.

Furthermore, if the output of the weight sensor indicates that the load carried by the smart hook is sufficiently intransient and greater than the stored tare value, if the altimeter indicates that the altitude of the smart hook is sufficiently intransient, and if outputs of the geospatial position module are changing, the smart hook can transmit a “loaded, moving laterally” status indicator to the computer system for publication to the manager portal. When the output of the weight sensor indicates that the load carried by the smart hook is sufficiently intransient and greater than the stored tare value and when outputs of the altimeter indicate that the smart hook is decreasing in altitude, the smart hook can transmit a “loaded, lowering” status indicator to the computer system for publication to the manager portal. As the output of the weight sensor then indicates that the load carried by the smart hook is decreasing, the smart hook can transmit an “unloading” status indicator to the computer system. Finally, when the output of the weight sensor reaches the stored tare value, the smart hook can: close (or “end”) the new lift event record; and transmit an “unloaded” status indicator to the computer system for publication to the manager portal.

While the output of the weight sensor remains at approximately the stored tare value, the smart hook can return “unloaded, lifting,” “unloaded, static,” “unloaded, moving laterally,” and “unloaded, lowering” status indicators to the computer system for publication to the manager portal.

Furthermore, the smart hook can: record timestamps of these status changes; record concurrent geospatial locations and altitudes of the smart hook; generate timestamped, georeferenced status indicators for these status changes; and write these timestamped, georeferenced status indicators to the lift event record.

### 7.6 Lift Event Record

The smart hook can then aggregate these data—such as including element type, weight, motion, geospatial location, altitudes, and photographic images collected by the smart hook while an element is loaded on the smart hook—into a lift event record for this element.

The smart hook can additionally or alternatively derive lift event metrics from these data and write these metrics to the lift event record. For example, in addition to load type, the smart hook can: identify a staging area where the element was stored based on the geospatial location and altitude of the smart hook when the element was first loaded onto the smart hook (i.e., the pickup location) and a local copy of a site map stored on the smart hook; identify a floor or level number and a wing or region of a building where the load was delivered based on the geospatial location and altitude of the smart hook when the element was unloaded and the site map; calculate an in-air time based on a duration between initial loading and final unloading of the element; calculate a static load time based on a duration of time that the smart hook was not moving laterally or vertically between the initial loading and final unloading of the element; and/or extract peak lateral speeds, peak vertical speeds, and peak height of the smart hook between the initial loading and final unloading of the element. The smart hook can then write these metrics to the lift event record for this element (such as in addition to or in place of raw sensor data recorded during this lift event).

Alternatively, the smart hook can transmit the lift event record for this element—including raw or filtered (e.g., de-noised) sensor data—to the computer system upon completion of the lift event (e.g., when the output of the weight sensor returns to the stored tare value), and the computer system can extract the foregoing metrics from these sensor data. Yet alternatively, the smart hook can stream these sensor data to the computer system during the lift event, and the computer system can aggregate these data into a lift event record and derive the foregoing metrics and smart hook statuses from these data.

### 7.7 Remote Lift Event Identification

Alternatively the computer system can execute the foregoing methods and techniques to identify an element loaded onto the smart hook and to generate a lift event record based on load, geospatial location, motion, and/or camera data collected and broadcast by the smart hook during operation at the construction site. For example, the smart hook can record and transmit these data to a local wireless gateway over a local wireless network. The wireless gateway—such as located inside a cab or near a base of the crane—can then return these data to a computer system (e.g., a remote server) via a computer network (e.g., a computer network, a local area network). Alternatively, the smart hook can transmit these data directly to the computer system, such as via a cellular network. The computer system can then execute of the method S100 remotely to generate lift event records and to trigger alarms for the construction site.

In another example, the smart hook transmits data to a local computing device located on the construction site—such as a desktop computer, laptop computer, or mobile device—via a local wireless network; and the local computing device then executes of the method S100 locally to generate lift event records for the construction site. However, the smart hook and/or any other local or computer system can execute of the method S100 in (near) real-time or asynchronously to automatically generate lift event records and to issue alarms for materials and equipment moved throughout the construction site by a crane.

### 8. Construction Task Identification

Block S122 of the method S100 recites correlating the first lift event with a particular construction task defined in the construction map of the site based on the first set of load characteristics and the first geospatial location. Generally, in Block S122, the computer system can link a current lift event occurring at the smart hook to a particular construction task in the construction map based on correlations between: a material, a material weight, a pickup location, and/or a time at the start of a lift event (e.g., as or just after the material is rigged to the smart hook); characteristics of this construction task defined in the construction map; and/or previous construction tasks detected at the construction site. In particular, as the load is rigged onto the smart hook and/or as the load is first lifted at the smart hook (i.e., before the load is unloaded at its drop-off location), the computer system can associate this lift event with a particular construction task by reconciling: other construction tasks recently detected at the smart hook versus outstanding construction tasks scheduled in the construction map; a load type (and weight) detected at the smart hook versus types (and sizes) of loads specified in construction tasks in the construction map; and a current location of the smart hook (e.g., the pickup location) and scheduled pickup locations for construction tasks specified in the construction map.

In one implementation, the computer system aggregates a set of incomplete construction tasks, such as outstanding (i.e., not yet started and not yet complete) construction tasks scheduled for completion prior to the current date and scheduled for initiation on the current date. The computer system then filters this set of outstanding construction tasks for construction tasks that specify: the same or similar material as identified in the current lift event; and/or pickup locations within a threshold distance of the current location of the smart hook. Then, if a single construction task remains in this filtered set, the computer system associates the current lift event with this sole remaining construction task and then executes Block S130. Alternatively, if multiple construction tasks remain in this filtered set, the computer system can pause execution of Block S130 and instead reassess the lift event based on additional lift event data received from the smart hook data as the load is moved to and unloaded at a drop-off location.

In another implementation, the computer system calculates a confidence score that the lift event corresponds to various outstanding construction tasks. In this implementation, the computer system aggregates a set of outstanding construction tasks, such as scheduled for completion prior to and on the current date, such as described above. Then, for a first construction task in this set, the computer system calculates a confidence score that the current lift event corresponds to this first construction task: proportional to a confidence score that the load includes a material specified in the construction task; inversely proportional to a difference between a size of the load and a weight of material indicated in this construction task; proportional to a spatial proximity of the current location of the smart hook to a pickup location specified in the construction task; and/or proportional to temporal proximity of the current time to a scheduled start time of the construction task (or to a predicted start time of the construction task based on start times, completion times, and/or current statuses of preceding construction tasks). The computer system then repeats this process for each other outstanding construction task in set. Then, if a single construction task in this set is associated with a confidence score that exceeds a preset confidence threshold, the computer system associates the current lift event with this construction task and then executes Block S130 accordingly. Alternatively, if multiple construction tasks in this set are associated with confidence scores that exceed this confidence threshold or if no construction task in this set is associated with a confidence score that exceeds this confidence threshold, the computer system can delay execution of Block S130 and instead reassess the lift event based on additional lift event data received from the smart hook as the load is moved to and unloaded at a drop-off location.

### 8.1 Examples

In one example implementation, in Block S1io, the computer system: accesses the building model that includes a set of discrete volumetric representations of concrete elements, structural steel elements, glazing elements, and/or ventilation elements, etc. of a building on the construction site; accesses the construction site plan that defines georeferenced locations for the building and material staging areas within the construction site; and accesses the building schedule that specifies an ordered sequence of construction tasks at the construction site (e.g., including receipt, movement, installation, and/or removal of materials and equipment throughout the construction site in the form of a calendar or Gantt chart). In Block S112, the computer system extracts the sequence of construction tasks from the building schedule. Then, for each construction task in this sequence of construction tasks, the computer system: extracts a material type from the construction task; links the construction task to a discrete volumetric representation in the building model; estimates a material quantity of the material type for the construction task based on a size of the discrete volumetric representation; estimates an unrigging geolocation of the material type for the construction task based on a position of the discrete volumetric representation in the building model, a location of the building in the construction site plan, and/or material staging areas defined in the construction site plan; and then stores the material type, the material quantity, and the unrigging location in a construction task element for the construction task.

For example, the computer system can link the construction task to a discrete volumetric representation in the building model based on: the material type and a material code of the volumetric representation in the building model; an order of the construction task in the sequence of construction tasks and a position of the volumetric representation in the building model (e.g., by pairing earlier construction tasks with volumetric representations at lower altitudes within the building model); and/or similarities between keywords or descriptive content in the construction task and the discrete volumetric representation in the building model.

Then, in this example implementation, the computer system can access an element type and an element weight detected by the smart hook during a lift event in Block S120 and correlate this lift event with a particular construction task based on: alignment between the element type and a particular material type specified in a particular construction task element for the particular construction task; alignment between the first element weight and a particular material quantity specified in the particular construction task element; and alignment between the drop-off location and a particular unrigging geolocation specified in the particular construction task element.

Furthermore, in this example implementation, for a first construction task in the sequence of construction tasks, the computer system can derive a link to one or a group of preceding construction tasks requiring completion prior to the first construction task, such as based on preset construction task order rules (e.g., concrete pour preceded by formwork side-B installation, preceded by rebar installation, preceded by formwork side-A installation; material installation preceded by material storage in a holding zone on the construction site preceded by material receipt at a receiving zone on the construction site). The computer system can repeat this process for other construction tasks in the sequence. Later, the computer system can correlate a lift event with a particular construction task further based on completion of a second construction task prior to the lift event if the particular construction task includes a link requiring completion of the second construction task prior to the particular construction task. Additionally or alternatively, in this example implementation, the computer system can access a set of confidence scores for types of an element carried by the smart hook during a lift event, a weight of the element, and a time of the lift event—such as derived locally by the smart hook—in Block S120. The computer system can then correlate this lift event with a particular construction task in Block S130 by identifying a subset of incomplete construction tasks in the sequence of construction tasks for the construction site. For each construction task in the subset of incomplete construction tasks, the computer system can calculate a similarity score between the lift event and the first construction task: proportional to a confidence score—in the set of confidence scores for types of the element carried by the smart hook during a lift event—for an element type specified in the construction task; inversely proportional to a difference between the weight of the element and a material weight specified in the construction task; proportional to a spatial proximity of the drop-off location to a material staging location specified in the construction task; and/or proportional to a temporal proximity of the time of the lift event to a scheduled start time of the construction task. The computer system can then correlate the lift event with a particular construction task—in the subset of incomplete construction tasks—if a similarity score of the particular construction task exceeds a threshold similarity score and similar scores for all other construction tasks in the subset of incomplete construction tasks. For example, the computer system can: calculate a similarity score between the first lift event and a first construction task including installation of the first building element based on the set of first lift event data; and correlate the first lift event with the first construction task in response to the similarity score exceeding a similarity threshold.

### 9. Smart Hook Unloading

In one variation, the computer system derives additional characteristics of this lift event based on data received from the smart hook as the load is moved to and unloaded at a drop-off location.

In one example, the computer system derives: a georeferenced 3D path from the pickup location to the drop-off location; an altitude and a geospatial location of the drop-off location; a floor of a building to which the load is delivered (e.g., based on the altitude of the drop-off location); a region or wing of a building to which the load is delivered (e.g., based on the geospatial location of the drop-off location); and/or an unload time from the smart hook from additional data received from the smart hook during this lift event. In another example, the computer system derives or confirms a status of the load based on the drop-off location of the load, such as by confirming an “inbound” status of a load rigged to the smart hook at a specified material receiving location and unloading at a material staging location on the construction site.

### 10. Construction Task Confirmation

In one variation, the computer system predicts or confirms an association between the current lift event and a particular construction task further based on the foregoing additional lift event characteristics.

In one example in which multiple construction tasks remain in a set of construction tasks filtered according to lift event characteristics derived from data collected at and around the pickup location, the computer system further filters this set of construction tasks based on proximity of drop-off location specified in the construction tasks and the actual drop-off location of the current lift event.

In another example, the computer system further refines a confidence score for association between a construction task and the current lift event proportional to proximity of the drop-off location specified in this construction task to the actual drop-off location of the current lift event. The computer system can then confirm an association between this lift event and a particular construction task for which the computer system has calculated a highest confidence score.

However, the computer system can implement any other method or technique to derive an association (or correlation) between the current lift event and a particular construction task in the construction map.

### 11. Construction Task Status

In one variation, after associating the lift event with a particular construction task, the computer system can interpret a new status of the particular construction task and update a construction record for the construction site accordingly.

In one implementation, the computer system interprets a first lift event in which a particular material is first unloaded within a perimeter of the building—following lift events specifying other materials and corresponding to other construction tasks—as the start of a next construction task specifying this material. The computer system then updates the status of this next construction task to “active” and stores a time of the lift event as a start time of this construction task. In this implementation, the computer system can also indicate that a second “active” construction task gating the newly-active construction task is now “complete” (or nearing completion) and store the time of the current lift event as an end time of this second construction task.

Later, in response to detecting a second (or third, fourth, etc.) lift event in which this same material is delivered at or near the same pickup location, the computer system can associate this second lift event with the same construction task and fuse quantities of the material delivered to the building across these lift events to estimate a degree of completion of this construction task. For example, the computer system can: estimate or extract a total weight of a material for this construction task from the construction map (e.g., five tons of formwork; 100 tons of concrete, 3000 pounds of drywall); track the weight of this material delivered to a particular floor or wing of the building across multiple lift events while the construction task specifying this material is active; estimate a proportion of the weight of this material delivered to the total weight of this material allocated to this construction task; and estimate the progress through this construction task (e.g., a proportion of the construction task completed) based on this proportion. The computer system can then update the status of this construction task according to the estimated proportion of the construction task completed and/or derive a progress rate of this construction task based on times of these lift events within this construction task.

However, the computer system can derive the status of this construction task in any other way. The computer system can then store the status of the computer system and a time of this status in the construction record for the construction site.

In one variation, the computer system derives additional metrics from data collected during this lift event and stores these data with an identifier of the construction task. For examples, the computer system can: aggregate a list of tools and equipment detected near the drop-off location; calculate net and gross durations of this lift event and other like lift events in this construction task; calculate a quantity of humans detected near the pickup and/or drop-off locations; calculate an in-air or motionless time of the load during the lift event; and/or calculate a difference between a quantity of a material delivered to a drop-off location and a quantity of the material planned for this region of the construction site. The computer system can then store these data with the construction task.

### 11.1 Updating First Task Status Based on a Second Task

In one implementation, the computer system can identify and update the status of a first construction task (e.g., installation of a first building element) in response to correlating a second lift event with a second task (e.g., installation of a second building element). In some instances, a building element may not be transported to an installation location by the crane. For example, a set of lightweight elements may be transported by a worker such as by hand of by forklift to the installation location. In this example, the crane does not lift the set of lightweight elements, and therefore the computer system: does not correlate event data from a lift event to a construction task including the installation of the set of lightweight elements; and does not record event data matching characteristics of the set of lightweight elements.

The computer system can correlate the first lift event with the first building element by: detecting a drop-off location of the first element proximal the installation location defined by the building model for the first virtual element associated with the first building element; for a second lift event at the crane, accessing second lift event data; based on the second lift event data of the second lift event, correlating the second lift event with a virtual element representing the succeeding building element to be installed following the first building element; and, based on correlating the second lift event with the succeeding building element, confirming installation for the first building element during the first lift event. Further the computer system can: update the building model to reflect installation of the first building element, such as by changing a color of the first virtual element to represent successful installation or removing and/or resolving an error notification associated with absence of detection of installation of the first building element.

For example, during a first time period, a set of framework for a concrete structure may be transported to the installation location and installed by a worker of the construction site. Therefore, the computer system does not detect installation of the set of framework during the first time. During a second time, after the concrete structure cures and the set of framework is stripped from the structure, the used set of framework may be loaded onto the crane to be disposed of at a location on the construction site separate from the installation location. In this example, the computer system can correlate the lift event including disposal of the used set of framework to the set of framework. The computer system thereby records detection of installation of the framework based on detection of disposal of the framework. Therefore, the computer system can detect and confirm installation of building elements lacking correlated lift event data.

### 12. Workers

In one variation, the computer system tracks: locations of workers moving throughout the construction site over time; and fuses construction task and worker location data to track workers (e.g., individual workers, workers within crews of particular trades) performing construction tasks on the construction site.

### 12.1 Worker Tracking Via Wearable Devices

In this variation, a population of mobile devices (e.g., smartphones) or wearable devices can be located on workers and can be configured to return locations of workers on the construction site to the computer system.

in one implementation, each wearable device can contain a shortrange wireless transmitter and can be located on a helmet worn by a worker on the construction site. In this example, a set of fixed local monitors can be arranged at known locations throughout the construction site. Each fixed local monitor can be configured to: broadcast queries, such as at a rate of once per minute; record inbound unique worker identifiers returned by nearby wearable devices responsive to these queries; and upload these unique worker identifiers and their locations to a worker location database.

In this implementation, the computer system can then: derive three-dimensional locations of each unique worker identifier—and therefore each individual worker—on the construction site at each sampling time based on known locations of local monitors that detected these unique worker identifiers returned by wearable devices worn by workers nearby; and assemble these three-dimensional locations of each unique worker identifier over time (e.g., since a start of construction on the construction site) into a temporospatial map of individual workers moving throughout the construction site—such as to a resolution of one minute and two meters throughout each workday. In this implementation, the computer system can also store and maintain a database of worker attributes associated with each unique worker identifier, such as: crew or group identifier; subcontractor affiliate; and/or trade type (e.g., welder, sheetrock installer, electrician, concrete form specialist). The computer system can then label the temporospatial map of individual workers with their worker attributes.

Later, the computer system can: extract a path traversed by a first worker—associated with a first worker identifier—over a first time period (e.g., one hour, one day) from the temporospatial map; derive a set of worker metrics for the first worker for the first time period from this path, such as total distance or steps traversed, walking speed, spent time in a work area, and/or spent time in a break area; and store this first set of worker metrics, attributes of the first worker, etc. in a first worker container (e.g., a vector) representing the first worker and the worker's movements on the construction site during the first time period.

The computer system can then repeat this process for each other time period in which the first worker is represented in the worker location database to generate a timeseries of containers representing the first worker at the construction site over time. The computer system can similarly repeat this process for each worker represented in the worker location database to generate timeseries of containers representing these workers at the construction site over time.

### 12.2 Worker Tracking Via Cameras

In another implementation, the computer system accesses: images captured by a set of optical plant sensors (e.g., cameras) arranged at known locations within the construction site, such as integrated into the smart hook and/or arranged on posts, fixed equipment, mobile equipment, and/or other structures within the computer system; implement computer vision techniques to detect workers and their locations within these images; repeat this process over time; and compile these worker locations into a temporospatial map of individual workers within the construction site over time.

In this implementation, the computer system can also: implement element tracking techniques to track workers moving within and between fields of view of these optical plant sensors; and/or implement human re-recognition techniques to detect and identify individual workers moving within the construction site. The computer system can then: derive characteristics of individual workers from these tracked or unique workers; and store these worker characteristics in the temporospatial map, as described above.

### 12.3 Worker+Construction Task Correlations

Therefore, the computer system can detect and track individual workers moving throughout the construction site over time.

For example, the computer system can implement methods and techniques described above to derive and store timeseries locations of individual workers—characterized by unique combinations of visual features detected in images captured by optical sensors arranged throughout the construction site and/or integrated into the smarthook.

Alternatively, the computer system can track and store timeseries locations of individual workers associated with unique identifiers broadcast over time by worker-worn devices and detected by sensors and routers arranged throughout the construction site.

Furthermore, the computer system can: implement methods and techniques described above to detect and track types and locations of elements moving across the construction site based on data captured by the smart hook (and/or other sensors deployed on the construction site); and correlate these types and locations of elements with construction tasks occurring on the computer system. The computer system can then link individual workers with particular construction tasks occurring on the construction site based on temporal and spatial proximity of individual workers to locations of elements and actions associated and prescribed in these construction tasks.

More specifically, the computing device can: track locations of actions occurring within the construction site over time; implement methods and techniques described above to associate a set of actions with a particular construction task defined in the build schedule; detect individual workers (or groups or workers, or “crews”) near these locations during these actions; and correlate these workers with these actions—and therefore with these construction tasks—based on spatial and temporal proximity.

Furthermore, the computer system can derive worker metrics for the construction task from paths traversed by workers around a location(s) of the construction task and other cotemporal data representing these workers, such as: a quantity of workers present during the construction task; worker flow (e.g., workers added and removed) during the construction task; worker step count; worker speed; and/or worker intensity (e.g., as a function of step count and speed); etc. In this implementation, the computer system can further: associate a group of individual workers performing an action during a construction task with a crew; associate this crew with a particular trade based on the action, associated element, or trade type prescribed in the corresponding construction task; and generate and store crew metrics, such as a quantity of workers in the crew present during the construction task and average worker step count, worker speed, and/or worker intensity within the crew during the construction task.

Therefore, the computer system can automatically: link workers with a construction task based on temporal and spatial proximity to an action defined in the construction task; associate these workers within a crew and predict their trade based on the construction task; derive worker metrics during the construction task based on worker motion and activity; and store these data in the corresponding construction task container. The computer system can repeat this process for other construction tasks, workers, and crews to derive and store representations of many crews present on the construction site over time, construction tasks they have completed, and characteristics of these crews and their actions while completing these construction tasks.

### 12.4 Worker Container

In one variation, the computer system stores these worker data in worker containers representing individual workers and/or groups of workers of a particular trade (or a “crew,” a “trade” affiliated with a particular subcontractor). Additionally or alternatively, the computer system can store these worker data in construction task containers corresponding to construction tasks performed by these workers and crews.

### 13. Mobile Assets

In another variation, a population of asset tags—such as similar to the wearable devices described above—can be similarly located or installed on materials and tools moving throughout the construction site.

Accordingly, the fixed local monitors described above can: broadcast queries; record inbound unique asset identifiers from nearby asset tags responsive to these queries; and upload these unique asset identifiers and their locations to an asset location database.

The computer system can then: derive three-dimensional locations of each unique asset identifier—and therefore the corresponding asset—on the construction site at each sampling time based on known locations of local monitors that detected these unique asset identifiers returned by these asset tags; and assemble these three-dimensional locations of each unique asset identifier over time (e.g., since first detected at the construction site) into a temporospatial map of individual assets moving throughout the construction site—such as to a resolution of one minute and two meters throughout each workday.

In one implementation, the computer system can also: store and maintain a database of asset attributes associated with each unique asset identifier; and label the temporospatial map of individual assets with their asset attributes. For example, the smart hook can also include a local monitor, such as described above, that interrogates asset tags on loads carried by the smarthook and records unique asset identifiers returned by these asset tags. Accordingly, the smart hook or the computer system can: write a unique asset identifier detected during a live event to the corresponding light element record; compile locations of this unique asset identifier—and the corresponding asset—detected by fixed local monitors with the trajectory of the smart hook during the lift event; label the unique asset identifier with attributes of the asset derived from data collected by the smart hook during the lift event (e.g., weight, load type); and update the database of asset attributes with these data.

Additionally or alternatively, the computer system can populate the database of asset attributes with asset attributes entered by workers when applying asset tags to materials and equipment entering or moving within the construction site.

Later, the computer system can extract a path traveled by a first asset—associated with a first asset identifier—over a first time period (e.g., one hour, one day) from the temporospatial map and derive a set of asset metrics for the first asset for the first time period from this path, such as: total distance traversed; time-in-air (i.e., time loaded on the smarthook); smart hook load and unload durations; crane path error (e.g., whether the asset moved outside of the permitted flight zone of the crane); asset movement speed; spent time in various work areas of the construction site; and/or whether the asset is located in a final installation location associated with the type of asset in the building model or site plan.

The computer system can repeat this process for each other time period in which the first asset is represented in the asset location database to generate a timeseries of containers representing the first asset at the construction site over time. The computer system can similarly repeat this process for each asset represented in the worker location database to generate timeseries of containers representing these assets at the construction site over time.

### 14. Errors

The computer system can further record types, times, and locations of errors occurring during construction tasks, such as: presence of a crane or element carried by the crane entering a no-fly zone; a dropped element; incomplete installation of an element; misordered element installation that blocks future installation of another element; removal of a previously-installed element; insufficient element (e.g., material) installation (e.g., insufficient concrete release, indicating incomplete formwork fill); excess element (e.g., material) installation (e.g., excess concrete release, indicated formwork failure); and/or worker injury.

For example, the computer system can interface with a user portal to receive manual entry and supporting data describing errors from a worker (e.g., a worker, sub-contractor, general contractor, super-intendent). Additionally or alternatively, the computer system can automatically detect these errors, such as described in U.S. patent application Ser. No. 17/896,874.

The computer system can then: implement methods and techniques described above to link these manually- and/or automatically-identified errors to particular construction tasks based on spatial and temporal proximity; and write these error data to corresponding construction task containers.

### 14.1 Error Notifications

The computer system can generate and transmit notifications indicating a detected error. The computer system can generate and transmit notifications including: push notifications, text messages, pop ups, and building element annotations. The computer system can generate and transmit notifications in response to detecting an error and predicting a future error.

In one implementation, the computer system: generates a notification; and populates the notification with a set of prompts and/or user input fields. For example, the computer system: generates a notification indicating an erroneous installation order of a building element; and populates the notification with a prompt for an operator to investigate for a) failed installation of a building element, b) failed detection of a lift event for a building element, and/or c) failed correlation of a lift event with the building element. The computer system can additionally populate the notification with a prompt for an operator of the computer system to confirm installation of a second building element without the crane prior to installation of the first building element. Therefore, the computer system can generate a notification to prompt an operator to provide additional information.

In response to additional information from a user input, the computer system can update the building model such as to: re-order future tasks; update a total build duration; and flag potential future errors based on historical errors.

The computer system can generate and transmit notifications in response to errors including: task duration above a target duration; task duration below a target duration; erroneous ordering of tasks; damage to a building element; excess crew members for a task; and incomplete tasks.

In one implementation, the computer system detects an error by accessing lift event data of a lift event at the crane. The lift event data can include a loading duration; motion duration; motionless duration; and unloading duration. The building model can include target durations for each portion of a lift event and, in response to a portion of the a lift event exceeding a target duration, the computer system can generate and transmit a notification to an operator indicating the error.

For example, the computer system can detect a motionless duration of a crane between a loading and unloading event. The motionless duration between loading and unloading of a building element may indicate a construction tasks was started before a preceding task was completed. For example, the building model can include: a first task including set up of an installation location; and a second task including installation of a building element at the installation location. If the second task is begun before the first task, a crew may load the building element onto the crane and then prepare the installation location for installation of the building element, resulting in the crane remaining motionless for a duration. Therefore, in response to the motionless duration exceeding a target motionless duration during the lift event, the computer system generates and transmits a notification to the operator. This notification can include a prompt to record an additional construction task completed during the motionless duration.

### 15. Construction Metrics

The computer system can also derive construction metrics for the construction site from these lift events and construction task statuses, such as: durations of individual construction steps occurring on the construction site; differences between planned and actual times to complete individual construction steps; and/or daily accrued construction delays; etc.

For example, the computer system can implement methods and techniques described above to match: construction tasks defined in the building model (e.g., a virtual building model), a site plan, and/or a building schedule; to lift events detected by the smart hook, movements of wearable device coupled to workers, and/or movements of asset tags coupled to materials and equipment, etc. The computer system can then aggregate a first set of characteristics of a lift event, worker movements, material movements, and/or equipment movements affiliated with a first construction task and derive a first set of construction task metrics from these characteristics, such as: a duration of the first construction task; types or material and/or equipment involved in the first construction task; path lengths traversed by these materials and/or equipment during the first construction task; a quantity of workers involved in the first construction task; a speed of these workers during the first construction task; etc.

For example, the computer system can derive and store additional element and construction task metrics and outcomes, such as: a duration between unloading at a staging zone and loading for final installation; a duration in air; rigging and unrigging times; a duration to install a beam following its arrival within a threshold distance of an install location; a duration of a concrete pour following arrival of a concrete hopper within a threshold distance of a pour location; a hook hover duration at a formwork strip location (which may indicate a formwork strip duration); and/or types, times, and locations of errors; etc. Additionally or alternatively, the computer system can derive: an element characteristic (e.g., weight, length, height, material type, element type, element format); and/or worker metadata (e.g., quantity of workers involved in a construction task, intensity or activity level of workers, worker trade, worker step count, worker flow during construction task). The computer system can then aggregate these metrics into a population of construction tasks representing and describing construction tasks—each including one or a sequence of actions at the construction site—completed on the construction site.

The computer system can also: extract similar planned metrics for the first construction task from the construction schedule and/or site plan; and calculate differences between these planned and actual metrics of the first construction task.

The computer system can then: initialize a first construction task container (e.g., a vector) for the first construction task; and populate the first construction task container with characteristics of the first construction task (e.g., construction task type, material or equipment type, construction task order), the first set of construction task metrics, and/or differences between planned and actual metrics of the first construction task.

### 16. Data Aggregation

Once the smart hook and/or other devices described above are deployed on a construction site, the computer system can execute the foregoing methods and techniques to: detect, identify, and track elements and workers (or crews, trades more generally) moving within the construction site; track progress according to the building model, site plan, and/or building schedule based on element and worker movements within the construction site; and store progress data—representing sequences of actions performed by workers (or crews, trades) to handle and install elements on the construction site.

More specifically, the computer system can: generate construction task containers, worker containers, and/or asset containers representing flow of workers, materials, and equipment throughout the construction site and sequences of actions performed by these workers on these materials and equipment at the construction site over time; track progress on the construction site according to the building model, site plan, and/or building schedule; and store these data in a construction site database associated with the construction site.

The computer system can execute this process at multiple construction sites over time—such as concurrently or in series at various construction sites in the same or different geographic regions—to: generate construction task containers, worker containers, and/or asset containers; track progress on each construction site in light of unique building models, site plans, and/or building schedules affiliated with these construction sites; and store these data in construction site databases affiliated with each construction site.

### 17. Construction Task Outcome Prediction for Individual Element Types

The computer system can then train a model to predict outcomes (e.g., install durations, errors) of future construction tasks based on data contained in the population of construction task containers.

In one implementation, the computer system: selects a target element type; searches the building model for elements of the target element type; and retrieves all construction task containers for elements of the target element type. For example, the computer system can select: all beams of the same length; or a first group of beams of within a first length range and a second group of beams of within a second length range. In another example, the computer system can select: all precast concrete sections; or a first group of precast concrete sections within a first weight, height, and/or length range and a second group of precast concrete sections within a second weight, height, and/or length range. In another example, the computer system can select: all rebar sections; or a first group of preformed rebar sections of the same or similar size and geometry and a second group of preformed rebar sections of a different size and/or geometry.

In this implementation, the computer system can then derive correlations between: data contained in these construction task containers; install durations; and errors. For example, the computer system can derive strengths of correlation between: install duration for the particular element type; and quantity of workers present, worker characteristics (e.g., trade, crew expertise, time onsite, consecutive hours worked), local weather conditions, ambient conditions (e.g., temperature, ultraviolet index), time of day, install location on the construction site, material holding location, element dimension, element weight, element install orientation, etc. In a similar example, the computer system derives strengths of correlation between: presence, type, and/or severity of error during installation of the particular element type; and quantity of workers present, worker characteristics (e.g., trade, crew expertise, time onsite, consecutive hours worked), local weather conditions, ambient conditions (e.g., temperature, ultraviolet index), time of day, install location on the construction site, material holding location, element dimension, element weight, element install orientation, etc.

### 17.1 Clustering

In one implementation, the computer system can implement clustering techniques to derive correlations between these characteristics and outcomes for installation of the particular element type.

In particular, in this implementation, the computer system can: aggregate all construction task containers for the target element type; plot construction task containers—with characteristics represented as quantitative values—as vectors in n-dimensional space; and implement clustering techniques to detect groups of construction task containers exhibiting similar install durations, similar presence or absence of errors, and similar combinations of other characteristics.

### 17.2 Machine Learning

In another implementation, the computer system implements artificial intelligence to derive a model representing strengths of correlation between these characteristics and outcomes for installation of the particular element type.

In particular, in this implementation, the computer system can: isolate a first subset of construction task containers in the set as training construction tasks; isolate a second subset of construction task containers in the set as test construction tasks; implement adversarial neural network techniques to train the model to predict outcomes (e.g., install durations, presence and absence of errors) given combinations of inputs based on the training construction task containers; and verify the model based on the test construction task containers.

However, the computer system can implement any other method or technique to derive correlations between these characteristics and outcomes for installation of the particular element type. The computer system can then repeat these processes for other element types installed throughout the construction site.

### 17.3 Element Type Subgrouping by Characteristic

In one variation, the computer system further segments elements—of the particular element type—by characteristic or characteristic ranges (e.g., beam length, element weight) and derives correlations between outcomes and characteristics for subgroups of each element type.

For example, the computer system can: implement clustering techniques to isolate subgroups of a first element type; isolate different element characteristics that delineate each subgroup of the first element type; and define subgroups of the first element type based on these element characteristics. In this example, the computer system can group: beams within a first length range installed within a first time duration; and beams within a second length range installed within a second time duration greater than the first time duration. The computer system can then implement methods and techniques described above to train individual models for these subgroups of elements of the particular element type.

In particular, different results (e.g., install duration, errors) within a cohort of the same element type may be due to: different element characteristics between elements of the same element type (e.g., different girder lengths and section geometries may yield different loading, locating, and installation requirements); different location characteristics (e.g., some install locations may be more difficult to access than others); different worker characteristics (e.g., different crews, different quantities of workers, different worker activity levels or strain prior to install, or different degrees of experience at the construction site); different environmental conditions during install; different installation orders for groups of elements installed near an element's install location; and/or different storage characteristics for the element prior to install.

Therefore, for a particular element type, the computer system can: derive correlations between a) the foregoing element characteristics and b) outcomes (e.g., install duration, error) based on data contained in a corpus of construction task containers representing actions on elements of the particular element type and exhibiting characteristics within a particular characteristic range.

More specifically, the computer system can: segment the population of installed instances of the particular element type—represented by this population of construction task containers—by quantitative ranges or qualitative characteristics exhibiting strong correlation with different outcomes (e.g., different ranges of install durations, different error types, different error frequencies); and define subgroups of the particular element type according to these quantitative ranges or qualitative characteristics. Then, for a first subgroup of the particular element type, the computer system can: derive correlations between a) the foregoing location, worker, environmental, and installation characteristics and b) outcomes (e.g., install duration, error) based on data contained in construction task containers representing the first subgroup of the particular element type; and derive sensitivities of the first subgroup of the particular element type to location, worker, environmental, and installation characteristics based on strengths of these correlations. Additionally or alternatively, the computer system can compile these correlations into a model that predicts outcomes for future instances of the particular element—with characteristics corresponding to the first subgroup—based on location, worker, environmental, and/or installation characteristics.

The computer system can then: repeat this process for each other subgroup of the particular element type; and repeat this process for each other element type.

### 17.4 Construction Task Order

In one variation, the computer system further derives correlations between order of a sequence of construction tasks (or actions within or between construction tasks) and outcomes (e.g., install durations, errors) for construction tasks designating particular element types. In particular, the computer system can store a detected completion order of a sequence of construction tasks in a construction task container representing a particular construction task in this sequence; and implement methods and techniques described above to derive (or train a model that represents) correlations between construction task sequence and outcomes for these similar construction tasks.

More specifically, the computer system can derive a correlation between: a type of a last element installed near the install location of a particular element prescribed in a particular construction task prior to installation of the particular element; and outcomes (e.g., install duration, errors) of the particular element and the particular construction task. Similarly, the computer system can derive correlations between: types of a set of (e.g., two, five) elements installed near the install location of the particular element—prescribed in the particular construction task—and the install order of these elements prior to installation of the particular element; and an outcome (e.g., install duration, errors) of the particular element and the particular construction task.

The computer system can implement similar methods and techniques to derive correlations between: order, duration, downtime between, and/or other characteristics of actions defined within a construction task; and an outcome (e.g., install duration, errors) of the construction task.

However, the computer system can implement any other method or technique to derive correlations and/or construct a model that represents correlations between a set of construction inputs (e.g., element type and characteristics, worker characteristics, site context, installation context); and install duration (or construction task more generally) and errors.

### 17.5. Misordered Tasks

The computer system can execute the method S100 to detect an erroneous installation order of a set of building elements. The building model can define a building schedule including an installation order for a set of building elements. In one implementation, the building model includes a set of virtual elements, each virtual element: linked to a preceding element to be installed prior to the virtual element; and linked to a succeeding element to be installed following installation of the virtual element. The building model therefore defines an installation order of: the preceding element, followed by the virtual element, followed by the succeeding element.

In one example, a set of building elements: includes a defined installation order within the building model; and includes a set of building elements for onsite fabrication of a concrete structure (e.g., rebar, inner formwork, outer formwork, and wet concrete). In general, installing a concrete wall can include, in order: installing primary framework; installing a set of rebar within a volume defined by the primary framework; installing secondary framework; pouring concrete within the primary and secondary framework; allowing the concrete to harden; and removing the primary and secondary framework. Therefore, for a concrete pillar structure within the building model, the building model can define an installation order including: installing the framework; installing the rebar; pouring the concrete; and removing the framework. The building model can define additional parameters of installation including a duration between each task in a set of ordered tasks. For example, the building model can define a minimal time duration (e.g., 1 minute) between installation of the primary framework and installation of the rebar, as the framework does not require a curing period. The building model can additionally define a curing duration between the pouring of the concrete and removal of the framework (e.g., 1-5 days) to allow the concrete to harden before removing the framework.

In this example, the method S100 can include accessing the lift event data for a first lift event at the crane including: detecting a pickup location of a volume of concrete; detecting a starting weight of the volume of concrete; detecting a drop-off location of the volume of concrete; and detecting a final weight of the volume of concrete. Then, the computer system correlates the first lift event with the volume of concrete by: matching the drop-off location of the first building element to a drop-off location of the volume of concrete within the virtual building model; calculating a change in weight of the volume of concrete between the final weight and the starting weight of the volume of concrete; and matching the change in weight to a predicted weight of the volume of concrete.

Further, the method S100 includes annotating a first virtual element in the virtual building model representing the volume of concrete by changing a color of the first virtual element from a first color to a second color, wherein the first color represents a virtual element that is not installed, and the second color represents a virtual element that is installed. The computer system then identifies a second virtual element within the building model, linked to and preceding the volume of concrete, defining a set of rebar. In response to the absence of detection of installation of the rebar associated with the second virtual element, prior to installation of the volume of concrete, the computer system generates a notification indicating erroneous installation of the volume of concrete before installation of the rebar. Therefore, the computer system identified the installation of the concrete prior to the installation of the rebar as misordered and notifies an operator.

### 17.6 Building Element Groups and Group Archetypes

The building model can further include a set of building element groups. Each element within a building element group defines a common characteristic. In the previous example, the volume of concrete, rebar, and framework define a common installation location and a concrete pillar group. In another example, a building element group can include a set of building elements to be installed during a single time interval, such as each individual piece of rebar in a support structure of rebar. The building model can define one or multiple construction tasks for each group. For example, the building model can define: a single construction task defining installation of the whole concrete pillar; and/or a set of construction tasks defining installation of each component of the concrete pillar. Therefore, the building model represents complete and incomplete construction tasks as well as complete and incomplete groups of construction tasks.

In one implementation, the computer system generates lift event data for a first lift, the lift event data including: a first pickup location; a first element weight; a first drop-off location; and a first drop-off time. The computer system can then, based on the first pickup location and the first element weight, correlate the first lift event with a first building element. For example, the computer system can: filter the building model to identify tasks including building elements within a threshold distance of the pickup location; filter the building model to identify tasks including a building element within a threshold weight interval (e.g., +/−5 kg); and correlate a building element and/or a construction task to the lift event based on a building element and/or construction tasks representing highest similarity to the lift event data.

The computer system executes the steps above to correlate a second lift event (including: a second pickup location; a second element weight; a second drop-off location; and a second drop-off time) to a second building element and/or second construction task, based on the second pickup location and the second element weight. The computer system can then detect a group of the first building element and the second building element based on: a proximity of the first drop-off location and the second drop-off location; and a proximity of the first drop-off time and the second drop-off time.

Further, the computer system can identify a group archetype from a set of group archetypes. A group archetype can define a set of parameters common to each building element within the group such as: a target arrangement of each of the building elements relative to each other; a target installation order; a target overall group installation duration; a target interval between each task of the group; and a set of historical data for similar groups.

In response to detecting a difference between the group archetype and the first lift event data and the second lift event data, the computer system can: generate a notification indicating a digression from the group archetype; and transmit the notification to an operator.

In one implementation, the computer system generates a group archetype from a user input, the user input defining: a building element installation order for building elements within the group; and a target installation duration for each building element within the group. For example, an operator or manager of the construction site can input a set of rules for each construction task within a group of construction task such as: a one hour installation duration per cubic foot of concrete poured; a three hour per square yard of framework target installation duration; an installation order defining installation of framework before pouring of concrete; and a curing duration of 5 days between pouring of the concrete and removal of the framework.

In one implementation, the computer system derives a group archetype based on historical construction task data including lift event data. The computer system can derive the group archetype based on historical data from the same construction sites or from a set of previous construction sites. For example, the computer system can: identify a set of building elements within a group; search a historical record of construction tasks involving a similar set of building elements or a subset of the set of building elements; access data for the similar set of building elements; and average lift event data from the similar set of building elements to calculate a set of rules within the group archetype. For example, the computer system can derive a rule within the group archetype indicating pouring of concrete including a target installation duration of 2.5-4 hours per cubic foot based on an average duration of previous concrete pours. Therefore, the computer system can generate group archetypes based on historical construction task data.

In another example, the computer system can derive a group archetype based on a set of preferred outcomes. The set of preferred outcomes can include: low total worker overtime; no injuries; task duration within target durations; and total building duration within an initial predicted building duration. The computer system: searches the historical record of construction tasks completed without error or completed within a minimal error threshold (e.g., a minimum range of worker overtime hours etc.) to calculate the set of rules for the group archetype.

### 18. Real-Time Predictions

The computer system can then implement this model to predict outcomes of future construction tasks planned in the building schedule.

In one implementation, the computer system retrieves current inputs for a next planned construction task on the construction site from the construction schedule, such as: characteristics of an element described by this construction task; a current staging or storage location of the element; and an install location of this element. The computer system similarly retrieves worker data for a crew assigned to complete this next planned construction task, such as: locations of workers within this crew currently located near the current storage or staging zone and/or planned install location of the element; durations that these workers have been onsite; and/or a daily current step count of these workers, etc. The computer system can further retrieve actions recently performed on the element and/or characteristics of other construction tasks recently completed near the planned install location of an element described in the next planned construction task.

The computer system then: injects these input data into the model to predict an outcome (e.g., install duration, risk of error, worker overtime hours) for this element; and returns these predictions to a user (e.g., a site superintendent, general contractor, subcontractor).

### 18.1 Input Sensitivity

In this implementation, the computer system can further: selectively perturb these inputs (other than element characteristics); and inject the element characteristics and these other perturbed inputs into the model to predict effects of changes to inputs on install duration and risk of error for the construction task.

For a small perturbation of a particular input (e.g., quantity of workers, additional preparation action, install of another element, install order modification) that results in a significant decrease in install duration and/or decrease in error risk, the computer system can: generate a recommendation to implement this minor change for the particular input; and transmit a notification containing the recommendation to the user.

Similarly, for a small perturbation of a particular input that results in a significant increase in install duration and/or increase in error risk, the computer system can: generate a recommendation to avoid deviation in this direction for the particular input; and transmit a notification containing the recommendation to the operator. Additionally or alternatively, in this example, the computer system can: generate a recommendation to implement a change in the opposite direction of this perturbation for the particular input in order to decrease risk of delays and errors; and transmit a notification containing the recommendation to the operator.

For example, in order to reduce install duration and/or reduce risk of errors, the computer system can execute the foregoing methods and techniques to prompt the user to: move a worker from another construction task to this next planned construction task; request overtime for another worker to remain onsite after a current shift to assist with this next planned construction task; wait to install the element until after another element is installed or other construction task is completed; perform a preparatory action on the element; or perform a preparatory action at the element's designated install location

### 19. Future Planning

The computer system can implement similar methods and techniques to predict outcomes for future planned construction tasks defined in the building schedule, such as on a subsequent day, week, or month.

In particular, the computer system can: select a planned future construction task defined in the construction schedule; and extract element characteristics and an element install location from this planned future construction task. The computer system can then retrieve planned input data from the construction schedule, such as: planned action order within the planned future construction task; planned install order for other elements around the target install location of the element; and/or a quantity of workers—within the crew associated with the action, planned future construction task, or element type—assigned to the planned future construction task and scheduled to be onsite during the planned future construction task; etc.

The computer system can then: inject these input data into the model to predict an outcome (e.g., install duration, risk of error) for the planned future construction task; and update the building schedule to reflect the predicted install duration for the future construction task.

In this implementation, the computer system can further: selectively perturb these inputs (other than element characteristics); and inject element characteristics and other perturbed characteristics into the model to predict effects of changes to inputs on install duration and risk of error. Then, for a small perturbation of a particular input (e.g., quantity of workers, additional preparation action, install of another element, install order modification) that results in a significant decrease in install duration and/or decrease in error risk for the planned future construction task, the computer system can: generate a prompt to confirm this change for the particular input in the building schedule; transmit a notification containing the prompt to the user; and update the building schedule accordingly if the prompt is confirmed by the user.

Conversely, for a small perturbation of a particular input that results in a significant increase in install duration and/or increase in error risk for the planned future construction task, the computer system can: generate a prompt to confirm a perturbation of the particular input in an opposite direction; transmit a notification containing the prompt to the user; and update the building schedule accordingly if the prompt is confirmed by the operator.

For example, in order to reduce install duration and/or reduce risk of errors for the planned future construction task, the computer system can prompt the user to: schedule additional workers for queue on the planned date of the construction task; reorder construction tasks; schedule preparatory actions on the element; and/or schedule preparatory actions at the planned element install location.

### 19.1 Construction Task Input Tradeoffs

In another implementation, the computer system implements methods and techniques described above to test changes in predicted outcome of the planned future construction task given perturbations of many inputs of many magnitudes and in many directions. The computer system then characterizes sensitivity of the outcome (e.g., install duration, risk of error)—for the planned future construction task—to each of these inputs proportional to magnitudes of changes in outcome predicted by the model given these perturbed inputs. The computer system can further repeat this process for other planned future construction tasks defined in the building schedule.

The computer system can then detect and characterize tradeoffs between related inputs into groups of planned future construction tasks to reduce exposure to high-sensitivity perturbations that negative predicted outcomes for the planned future construction task, and vice versa.

For example, the computer system can: identify a set of construction tasks scheduled for the same time window (e.g., one day) and assigned to the workers within the same trade; predict that moving workers from a first construction task in this set characterized by low sensitivity to worker count (around a current worker count scheduled and allocated for the first construction task) to a second construction task in this set characterized by high sensitivity to worker count (around a current worker count scheduled and allocated for the second construction task) will reduce total install duration and/or error risk for this set of construction tasks; and automatically update the building schedule accordingly or prompt the user to manually enter this change.

In another example, the computer system can: identify a set of construction tasks scheduled for the same time window (e.g., one day); predict that moving a first, earlier-scheduled construction task in this set characterized by low sensitivity to installation order after a second construction task in this set characterized by high sensitivity to installation order will reduce total install duration and/or error risk for this set of construction tasks; and automatically update the building schedule accordingly or prompt the user to manually enter this change.

In this implementation, the computer system can additionally or alternatively execute the foregoing processes based on perturbed input values entered manually by the user in order to enable the user to explore how changes in inputs into planned future construction tasks at the construction site affect predicted install duration and risk of error.

### 19.2 Updating the Building Model

The computer system can update the building model based on predicted outcomes of future tasks. The computer system derives predictions of future task characteristics (e.g., duration, error risk, etc.) based on data collected from the construction site. Therefore, as construction progresses, the computer system can: input new data into the model to generate a set of updated predictions; and update the building model based on the set of updated predictions.

In one implementation, the computer system defines a group archetype including an installation order indicating a first building element installed before a second building element within a target duration. The computer system can detect installation of the second building element prior to installation of the first building element, representing an erroneous installation order. The computer system then calculates an installation duration for the erroneous installation less than the target duration following the installation order. The computer system can predict that, based on the erroneous installation order of these tasks, other groups of tasks may benefit (e.g., be completed faster, with higher efficiency, with less error) from the same installation order. The computer system can therefore generate a notification including a prompt for an operator to approve a revision of the group archetype. In this example, the revision can include updating the installation order within the group archetype to reflect the second building element installed before the first building element. In response to receiving a user input indicating approval of the revision prompt, the computer system can update a set of future construction tasks similar to the installation of the first building element and the second building element to indicate that installation of the second building element occurs before installation of the first building element. The computer system can then recalculate a predicted total construction duration based on the updated set of future construction tasks.

In one implementation, the computer system: determines a set of building elements to be installed in the future, defining an installation order matching the installation order of the first building element and the second building element; and updates the building model to modify the set of building elements to change the installation order of the set of building elements based on the proposed change; and modifies the set group of tasks within the building model to reflect the new installation order.

In one implementation, the computer system predicts a duration of future lift events correlated with building elements of a same element type as a first building element based on a duration of the first lift event correlated with the first building element. The computer system updates a total construction duration by: searching the building model for elements of the target element type; accessing a set of future construction tasks for building elements of the same element; modifying an initial duration of the set of future construction tasks to the predicted duration; and calculating the total build duration based on a total duration of all future construction tasks.

The computer system can additionally update the building model to include additional construction tasks. For example, in response to detecting a set of building elements installed misordered, the computer system can update the building model to include tasks to uninstall the previous building elements and reinstall the building elements in the target installation order.

### 20. Inter-Site Model

In one variation, the computer system implements the foregoing methods and techniques to: aggregate many construction task containers representing many construction tasks previously completed at many other construction sites; train a generic model to predict construction task outcomes given construction task inputs based on these construction task containers; and implement this generic model at the construction site to predict construction task outcomes during an initial construction period at the construction site.

Later, the computer system can: retrain the model or train a new, site-specific model based on data collected specifically at the construction site; and then implement this new model to predict outcomes at the construction site and/or to automatically adjust the building schedule as described above.

### 21. Visualizations

In one variation, the computer system interfaces with a user portal—accessed via the user's computing device—to generate and render a visualization of the construction site, including historical (i.e., actual) outcomes of completed construction tasks and predicted outcomes of incomplete construction tasks based on the population of construction tasks and the model(s) described above.

### 21.1 Predicted Deviation from Planned Install Duration

In one implementation, the computer system: accesses the building model and the building schedule for the construction site; and scans the building model for individual elements. For a first element detected in the building model, but not yet installed (or otherwise located) in the building, the computer system: extracts an element type and other characteristics of the element from the building model; identifies a particular element type subgroup corresponding to the element; and retrieves a construction task associated with the element. The computer system then retrieves predicted inputs for the construction task from or based on the building schedule and the building model, such as: other elements near the install location of the element and planned for install before the element; a quantity of workers scheduled to install the element or otherwise perform actions prescribed in the construction task; the install location of the element defined in the building model; and/or a weather forecast for the date of scheduled installation of the element; etc.

The computer system then: implements a model associated with the particular element type subgroup to predict outcomes for the construction task (e.g., install duration, risk of errors) based on these predicted inputs; and labels the element with the particular element type subgroup and the predicted outcomes for the construction task. The computer system repeats this process for each other element represented in the building model.

The computer system then: assigns a color (or texture, or other visualization characteristic) to each element type subgroup represented in the building model; initializes a visualization of the building model within the user portal; renders a representation of each element—in the set of elements not yet installed at the construction site—in the color of its element type subgroup within the building model; and renders representations of elements previously installed at the construction site in a different color or opacity within the building model.

Furthermore, for each element in this set of uninstalled elements, the computer system can: highlight the element—such as with a halo, change in color opacity, or caption box—if the predicted install duration for the element exceeds a planned install duration of the element by more than a threshold difference (e.g., 1%, 20%) and/or if the computer system predicts an error during installation of the element.

The computer system can thus enable the user to quickly visually perceive predicted install duration deviations for elements not yet installed at the construction site.

### 21.2 Heatmap: Install Duration

In another implementation, the computer system selects a particular element type. For a first set of elements of the particular element type that were previously installed on the construction site, the computer system: retrieves corresponding construction task containers; retrieves historical install for these elements from these construction task containers; highlights representations of this first set of elements in the building model by color value corresponding to historical install duration (e.g., with shortest install durations represented in “green” color values and longest install durations represented in “red” color values); and renders representations of the first set of elements—depicted or highlighted in colors corresponding to their historical install durations—in the visualization of the building model at the user portal.

In this implementation, for a second set of elements of the particular element type that are not yet installed on the construction site, the computer system: implements methods and techniques described above to predict install durations for these elements; highlights representations of this second set of elements in the building model by color value corresponding to predicted install duration (e.g., at lower opacity that the first set of elements of this element type); and renders representations of the second set of elements—depicted or highlighted in colors corresponding to their predicted install durations—in the visualization of the building model at the user portal.

Therefore, in this implementation, the computer system can annotate representations of this element type in the building model based on historical (i.e., actual, recorded) and/or predicted install durations, thereby enabling the user to rapidly perceive progress and progress variance on the construction site for similar instances of the element type.

### 21.3 Heatmap: Other Values

Additionally or alternatively, the computer system can implement similar methods and techniques to annotate representations of installed and uninstalled instances of an element type according to other historical and predicted values, such as including: install start time of day; install completion time of day; presence of errors during installation; quantity of workers involved in installation (e.g., peak quantity, average quantity, or total quantity of unique workers involved in all actions related to installation of an element); and/or quantity of overtime hours tallied during installation; etc.

For example, in this implementation, the computer system can: present a list of element type or element type subgroups to the user; present a menu of the foregoing characteristics or parameters to the user; generate a visualization depicting all installed and uninstalled elements of a particular element type or element type subgroups selected by the user; retrieve historical values and generate predicted values for a particular characteristic or parameter selected by the user; and selectively annotate these element representations according to their corresponding historical and predicted values.

### 21.4 Heatmap: Element Groups+Assemblies

The computer system can implement similar methods and techniques to generate visualizations of assemblies of elements of the same or dissimilar element types, such as a cluster of girders, formwork, rebar, and concrete that form a structure level of the building.

For example, the computer system can: query the building model for a definition of a group of elements that form a repeated assembly within the building; and isolate repeated instances of this group of elements. Then, for each instance of this element group that was previously installed, the computer system can: retrieve construction task containers associated with these elements; aggregate install characteristics (e.g., install duration, quantity of workers involved in installation) from these construction task containers into composite characteristics of the instance of the element group; and annotate (e.g., re-color) the element group—within the visualization—according to a particular characteristic selected by the user. Similarly, for each instance of this element group that was not previously installed, the computer system can: implement methods and techniques described above to predict install durations and other install characteristics for each element in these element groups (e.g., based on the building schedule); aggregate install characteristics from these construction task containers into composite characteristics of the instance of the element group; and annotate this element group in the visualization of the building according to these compiled predicted characteristics and the visualization characteristic selected by the user.

### 21.5 Additional Visualizations

The computer system can implement similar methods and techniques to generate additional visualizations including: installation statuses; error annotations; and predicted errors.

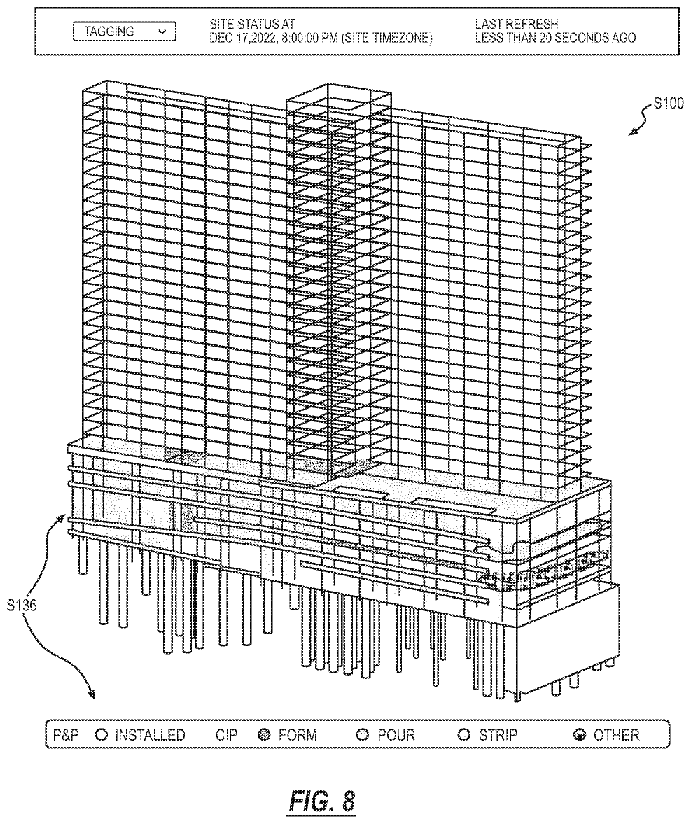

In one implementation, the computer system renders the constellation of virtual elements within the virtual building model on a display. The computer system: can generate a virtual element defining a three-dimensional representation of each building element within the building model; and annotate, as shown in FIG. 8, each virtual element to indicate a status of the element.

For example, in response to detecting installation of a first building element, the computer system: renders the first virtual element in a first color corresponding to detected installation of the first building element; and, in response to the absence of detection of installation of the second building element, renders the first virtual element in a second color corresponding to a possible installation error.

Further, in response to detection of a difference between the group archetype, the first lift event data, and the second lift event data, the computer system renders a first virtual element and the second virtual element within the group in a color corresponding to an error detected.

In one implementation, the computer system renders a visualization of a daily update to the building model. For example, the computer system can render a visualization of currently completed components of the building model. In another example, the computer system can render a visualization of construction tasks scheduled to be completed within a given time interval (e.g., a day, a week, a month). Therefore, the computer system can simplify a visualization of the building model to show only relevant portions of a building or construction site (e.g., indicating tasks recently completed and tasks to be completed within a next time interval). The computer system further annotates each building element within the building model to indicate predicted errors and error risks.

### 22. Worker Scheduling and Overtime

The computer system can implement the model(s) and methods and techniques described above to: predict total workers hours—in each trade—to complete a future planned construction task; to predict overtime hours by workers in each trade to complete these construction tasks; to predict how changes in worker quantities assigned to these construction tasks, building schedule changes, changes in construction site characteristics, and/or different environmental conditions at the construction site may effect different total workers hours and overtime hours for these construction tasks; and present these predictions to the user to inform modification to the building schedule, worker contracts, etc. at the construction site.

For example, the computer system can: select a set of construction tasks—scheduled for a future date and assigned to a particular trade or crew—from the building schedule; retrieve a quantity of workers in this trade or crew assigned to this set of construction tasks and scheduled to be onsite on the future date; implement methods and techniques described above to predict install durations of each construction task in this set; and estimate a quantity of worker hours by this crew to complete each construction task in this set, such as by dividing the predicted install duration of a construction task in this set by the quantity of workers in the crew assigned to this construction task.

The computer system can then: sum these worker hour quantity estimates for this set of construction tasks to estimate total daily worker hours to complete all planned construction tasks for this future date; multiply the quantity of workers in the trade or crew by the a nominal daily pre-overtime hour maximum to calculate a total quantity of pre-overtime hours on the future date; and predict a quantity of overtime hours within the crew on the future date based on a quantity of total daily worker hours in excess of the quantity of pre-overtime hours.

The computer system can also implement methods and techniques described above: to perturb inputs in the model, such as including worker count assigned to these construction tasks, environmental conditions, and construction task order; and to calculate install times for the construction tasks based on these different input conditions. The computer system can then: repeat the foregoing process to predict quantities of overtime hours within the crew on the future date for these different input conditions; and characterize sensitivities of install durations, total worker hours, and overtime hours for these construction tasks to these input conditions.

The computer system can then implement methods and techniques described above to present these data to the user (e.g., a superintendent) via the user portal, such as including: nominal overtime estimates for the scheduled crew; predicted overtime estimates given different quantities of workers present and other input conditions; and sensitivities of these predicted metrics to input conditions. For example, the computer system can label individual elements—corresponding to these construction tasks—in the building model with these predicted metrics. Furthermore, the computer system can: prompt the user to select alternative inputs (e.g., changes in worker counts) in order to reduce total worker hours on the future date and/or adjust predicted overtime hours for the crew to within a target range or threshold set by the user; and update the building schedule and/or worker and crew schedules accordingly.

The computer system can repeat this process for sequences of construction tasks defined in the building schedule for other future dates to predict total worker hours and overtime hours per day, per week, per month, per year, or per project, etc. for the construction site and to inform changes in the building schedule and/or worker schedules accordingly.

The computer system can implement similar methods and techniques to generate predictions for in-process or upcoming construction tasks (e.g., scheduled for the current date), such as: a quantity of workers of a particular trade needed to complete a construction task by a particular time on the current date, such as within the workers' current shift or within a threshold quantity of overtime hours after end of this shift; a probability of requiring overtime for completion of a construction task by the scheduled quantity of workers currently onsite given current onsite conditions and worker characteristics; a quantity of overtime hours necessary for completion of a construction task by the quantity of workers currently onsite given current onsite conditions and worker characteristics; and/or effects of increased or decreased quantities of workers—performing a construction task—on completion time of the task (and start and completion times of subsequent construction tasks by the same or other workers).

### 22.1 Worker Overtime Scheduling

In one implementation, the computer system: selects an upcoming planned construction task from the building schedule; retrieves a shift start time and a shift end time for a crew assigned to complete the construction task; and inserts construction task characteristics, current construction site conditions, worker characteristics of this crew, etc. into the model described above to predict a completion time of the construction task. If the construction task completion time succeeds the shift end time, the computer system: predicts a need for overtime for the crew; and updates an overtime schedule to reflect this prediction prior to start of the construction task.

### 22.2 Crew Expansion for Construction Task Completion

Alternatively, in the foregoing implementation, the computer system can generate a recommendation for addition of workers to the crew in order to avoid overtime hours and/or improve probability of timely completion of the construction task without error within an overtime window.

For example, the computer system can: retrieve historical overtime data on ratio of workers in crew who historically agreed to overtime; predict a quantity of overtime workers in the crew who will agree to overtime based on historical overtime data and quantity of pre-overtime workers currently in the crew; set a maximum overtime window (e.g., four hours after end of shift); and insert a predicted quantity of overtime workers in the crew and construction task and construction site characteristics into the model to predict a completion time of the construction task under current conditions. Then, if the predicted completion time given the predicted quantity of overtime workers succeeds the maximum overtime window, the computer system can: repeat this process for a greater quantity of pre-overtime workers in crew; and generate a recommendation to add workers to the crew in order to increase probability of completion of the construction task within the maximum overtime window.

### 22.3 Crew Reduction for Timed Construction Task Completion

Conversely, if the predicted completion time of the construction task is before the shift end time, the computer system can generate a recommendation to reduce the crew size in order to achieve construction task completion closer to the shift end time, thereby matching crew size to construction task duration (e.g., difficulty, quantity of actions involved) and planned shift start and end times.

### 22.4 Task Completion Prior to Related Scheduled Event

In one variation, the computer system autonomously coordinates worker quantity (i.e., crew size) and/or overtime within a crew of a particular trade in order to achieve completion of a particular construction task assigned to this crew prior to a scheduled start time of a next construction task, action, or event on the construction site gated by the particular construction task. In particular, a scheduled event on the construction site may require completion of a particular construction task prior to start, such as: a scheduled rebar inspection requiring completion of rebar install; a scheduled concrete delivery requiring completion of formwork assembly; and a scheduled rooftop HVAC unit installation requiring completion of a roofing install. Therefore, the computer system can predict a quantity of workers needed to complete a particular construction task prior to a scheduled start time of a scheduled event linked to the particular construction task.

In one implementation, the computer system: scans the building schedule for a next external event (e.g., formwork inspection at 9AM on the next day); extracts start time of the external event; and detects a particular construction task—linked to (e.g., gating) the external event and immediately preceding the external event—in the building schedule. The computer system then implements methods and techniques described above to estimate a completion time of the construction task and a predicted risk of error for the construction task, such as given forecast conditions at the construction site and a quantity of workers in the crew during the scheduled time of the construction task.

Then, if the predicted completion time of the construction task precedes the start time of the external event by more than a safety factor (e.g., 15% of the estimated duration of the construction task; two hours; one day) and the predicted risk of error is less than a threshold risk, the computer system can confirm the current quantity of workers scheduled for and assigned to the construction task.

However, if the predicted completion time of the construction task—given the current quantity of workers scheduled in the crew—precedes the start time of the external event by less than the safety factor or succeeds the start time of the external event and/or if the predicted risk of error for the construction task is greater than the threshold risk, the computer system can repeat the foregoing process to predict completions times and risks of error for the construction task for additional quantity of workers present to perform this construction task. The computer system then: generates a recommendation for a particular quantity of additional workers (or a new target total quantity of workers) in the crew to support completion of the construction task prior to the scheduled start time of the external event; serves the recommendation to the user; generates a new worker order (or updates an existing worker order) for additional workers in the crew if confirmed by the user; disseminates this worker order to a manager affiliated with the crew (e.g., a subcontractor); and updates the building schedule according to the updated quantity of workers scheduled for the planned date and time of the construction task.

Additionally or alternatively, the computer system can: implement methods and techniques described above to predict a quantity of overtime hours required by the current scheduled quantity of workers in the crew needed to complete the construction task prior to the scheduled start time of the external event; present this predicted quantity of overtime hours to the user via the user portal; and coordinate these overtime hours with the manager of the crew or execute the foregoing process to update the quantity of workers scheduled to complete the task (e.g., to avoid some or all of these overtime hours) based on a response supplied by the user.

### 22.5 Construction Task Order Definition with Worker Order and Overtime Prediction

In a similar variation, the computer system can derive a particular sequence of construction tasks within a particular time window (e.g., a current day) to control total overtime hours and/or completion time of these construction tasks, such as for a set of construction tasks assigned to a single crew of workers within a particular trade or for multiple crews spanning multiple trades.

In one implementation, the computer system: groups a set of construction tasks—for installation of elements in a particular region of the construction site—not assigned a rigid order (i.e., a set of construction tasks that may be completed in a variety of orders); and calculates a set of order permutations for this group of construction tasks. The computer system then implements methods and techniques described above to predict completion times, install durations, total worker hours, total worker overtime hours, and/or error risk for each construction task in the group for each order permutation based on current or forecast conditions at the construction site, quantities of workers in crews assigned to these construction tasks, environmental conditions, etc. during estimated times of the construction tasks prescribed by these order permutations. The computer system further aggregates these task-specific predictions into predicted aggregate completion times, aggregate install durations, aggregate total worker hours, aggregate total worker overtime hours, and/or aggregate error risk for each order permutation.

In this implementation, the computer system then selects a particular construction task order permutation characterized by earliest aggregate completion time, shortest aggregate install duration, least aggregate total worker hours, least aggregate total worker overtime hours, and/or least aggregate total error risk. For example, the computer system can prioritize a particular parameter in this set or a combination of these parameters based on priorities supplied by the user, such as: minimum construction duration without overtime hours and maximum total worker hours; or lowest risk of error while maintaining a construction calendar to achieve a target job completion date.

The computer system then recalculates aggregate completion times, aggregate install durations, aggregate total worker hours, aggregate total worker overtime hours, and/or aggregate error risk for the particular construction task order permutation based on different quantities of workers in the assigned crew(s) to derive sensitivity of these predictions to more or fewer workers.

Accordingly, the computer system can: update the building schedule to reflect the particular construction task order permutation; present sensitivity of these aggregate predictions to worker quantity to the user; prompt the user to augment crews—assigned to construction tasks characterized by high sensitivity to worker quantity —with additional workers; and selectively update worker orders for these crews during the time interval of these construction tasks based on response entered by the user.

### 22.5.1 Construction Task Order Definition Time Interval

In a similar implementation, the computer system executes the forgoing methods and techniques at the beginning of a construction day to automatically set a construction task order for the current day, place workers orders for target worker counts within trades and crews assigned to these construction tasks contractors, and/or place orders for planned overtime within these crews.

### 22.6 Overtime Withholding

In another variation, the computer system: implements methods and techniques described above to detect and track workers completing a particular construction task (e.g., based on wearable devices worn by workers or video streams captured by cameras arranged on the construction site); derives an actual quantity of workers present for the construction task; and retrieves a contracted quantity of workers for the construction task. If the actual count of workers present during the computer system is less than the contracted quantity of workers for the construction task, the computer system can generate a prompt to: withhold overtime from crew; request overtime without overtime pay to compensate for incomplete contracted work within a contract window; investigate the crew for absent workers; and/or request additional backfill workers to enable completion of the construction task by a target completion time. The computer system can then serve this prompt to the user.

Additionally or alternatively, if the actual count of workers present during the computer system is less than the contracted quantity of workers for the construction task but the computer system is currently on-track for completion by a target completion time specified in the building schedule, the computer system can update a worker order for similar future construction tasks to reflect this reduced worker quantity.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
accessing a virtual building model defining a constellation of virtual elements:
each virtual element:
representing a building element of a building on a construction site;
associated with an installation location of the building element;
linked to a preceding virtual element, in the constellation of virtual elements, representing a preceding building element installed in the building prior to the building element; and
linked to a succeeding virtual element, in the constellation of virtual elements, representing a succeeding building element installed in the building following the building element;
for a first lift event at a crane, accessing first lift event data;
based on the first lift event data of the first lift event, correlating the first lift event with a first building element represented by a first virtual element in the virtual building model;
in response to correlating the first lift event with the first building element:
annotating the first virtual element in the virtual building model with detection of installation of the first building element;
identifying a second virtual element, in the constellation of virtual elements, linked to and preceding the first virtual element in the virtual building model; and
in response to absence of detection of installation of a second building element, associated with the second virtual element, prior to installation of the first building element:
generating a notification indicating an erroneous installation order of the first building element; and
transmitting the notification to an operator.

2. The method of claim 1, wherein correlating the first lift event with the first building element comprises:
calculating a similarity score between the first lift event and a first construction task comprising installation of the first building element based on the set of first lift event data; and
correlating the first lift event with the first construction task in response to the similarity score exceeding a similarity threshold.

3. The method of claim 1:
wherein generating the notification indicating erroneous installation order of the first building element comprises populating the notification with a prompt:
to investigate for:
failed installation of the second building element;
failed detection of a lift event for the second building element; and
failed correlation of a lift event with the second building element; and
to confirm installation of the second building element without crane prior to installation of the first building element.

4. The method of claim 1, further comprising:
rendering the constellation of virtual elements within the virtual building model on a display;
in response to detecting installation of the first building element:
rendering the first virtual element in a first color corresponding to detected installation; and
in response to the absence of detection of installation of the second building element:
rendering the first virtual element in a second color corresponding to installation error.

5. The method of claim 1:
wherein accessing the virtual building model defining the constellation of virtual elements comprises:
accessing the first building element comprising a volume of concrete; and
accessing the second building element comprising rebar;
wherein accessing the first lift event data for the first lift event at the crane comprises:
detecting a pickup location of the first building element;
detecting a starting weight of the first building element;
detecting a drop-off location of the first building element; and
detecting a final weight of the first building element;
wherein correlating the first lift event with the volume of concrete comprises:
detecting the drop-off location of the first building element within a target radius of a drop-off location of the volume of concrete within the virtual building model;
calculating a change in weight of the first building element between the final weight and the starting weight of the first building element; and
matching the change in weight to the volume of concrete;
wherein annotating the first virtual element in the virtual building model comprises changing a color of the first virtual element representing the volume of concrete from a first color to a second color wherein:
the first color represents a virtual element that is not installed; and
the second color represents a virtual element that is installed;
wherein identifying the second virtual element linked to and preceding the first virtual element comprises identifying the rebar; and
wherein, in response to the absence of detection of installation of the rebar associated with the second virtual element, prior to installation of the volume of concrete:
generating a notification indicating erroneous installation of the volume of concrete prior to installation of the rebar.

6. The method of claim 1, wherein accessing the virtual building model comprises:
accessing a volumetric representation of the building on the construction site comprising virtual representations of each building element as a virtual element;
accessing a site plan comprising:
a layout of the construction site;
building element pickup and installation locations;
a crane location; and
a crane access area; and
accessing a building schedule comprising:
a set of construction tasks, each construction task defining a target task duration; and
a target construction duration.

7. The method of claim 1:
wherein accessing first lift event data for the first lift event at a crane comprises:
accessing a first timeseries of load values output by a weight sensor, coupled to a crane hook, during a first time period;
accessing a first geospatial location of the crane hook during loading of an element onto the crane hook during the first time period;
deriving a lifting profile at the first geospatial location from the first timeseries of load values; and
deriving a first weight of the element from the first timeseries of load values; and
wherein correlating the first lift event with the first building element based on the first lift event data of the first lift event comprises:
identifying a type of the element carried by the crane hook during the first time period based on the lifting profile;
accessing a second geospatial location of the crane hook during unloading of the element from the crane hook; and
generating a lift event record defining the type of the element, the first weight of the element, a pickup location of the element at the first geospatial location, and a drop-off location of the element at the second geospatial location.

8. The method of claim 1:
wherein accessing the virtual building model comprises accessing the installation location of the building element, the installation location defining a three-dimensional geolocation comprising a latitude, longitude, and altitude; and
wherein correlating the first lift event to the first building element represented by the first virtual element comprises:
detecting, from the first lift event data, a drop-off location of the first building element defining a three-dimensional geolocation; and
detecting the drop-off location within a threshold area of the installation location of the first building element.

9. The method of claim [0023]:
wherein accessing the virtual building model comprises accessing the virtual building model:
defining the first virtual element comprising a steel girder; and
defining an installation location of the first element comprising a geolocation associated with a target face of a target floor of the building; and
wherein correlating the first lift event to the first building element represented by the first virtual element comprises:
accessing a location of a hook of a crane during an unloading phase of the first lift event;
accessing an altitude of the hook of the crane during an unloading phase of the first lift event; and
in response to the location of the hook of the crane within a threshold distance of the target face and the altitude of the hook of the crane within a threshold height of the target floor:
correlating the first lift event to the first building element.

10. The method of claim 1, further comprising:
predicting an expected duration of installation of the second building element followed by installation of the first building element;
recording a first duration of installation of the first building element followed by installation of the second building; and
responsive to the first duration less than the predicted duration, generating a notification indicating a proposed change to the building model, the proposed change reflecting a reordering of construction tasks and decreasing a predicted total construction duration.

11. The method of claim 10, further comprising:
determining a set of building elements to be installed in the future defining an installation order matching the installation order of the first building element and the second building;
updating the building model to modify the set of building elements to update the installation order of the set of building elements based on the proposed change; and
modifying the set group of tasks within the building model to reflect the new installation order.

12. The method of claim 1, further comprising:
predicting a duration of future lift events corresponding to building elements of a same element type as the first building element based on a duration of the first lift event correlated with the first building element; and
updating a total construction duration by:
searching the building model for elements of the target element type;
accessing a set of future construction tasks for building elements of the same element;
modifying an initial duration of the set of future construction tasks to the predicted duration; and
calculating the total build duration based on a total duration of all future construction tasks.

13. The method of claim 1:
wherein accessing first lift event data of the first lift event at the crane comprises:
accessing a timeseries of location data of a hook of the crane, the timeseries of location data representing the location of the hook of the crane over an interval of time; and
further comprising:
in response to detecting a motionless duration of the hook of the crane based on the timeseries of location data:
detecting an error;
generating a notification indicating the error; and
transmitting the notification to the operator.

14. The method of claim 1, wherein correlating the first lift event with the first building element comprises:
detecting a drop-off location of the first element proximal the installation location defined by the building model for the first virtual element associated with the first building element;
for a second lift event at the crane, accessing second lift event data;
based on the second lift event data of the second lift event, correlating the second lift event with a third building element represented by a third virtual element in the virtual building model, the third virtual element representing the succeeding building element to be installed following the first building element; and
in response to correlating the second lift event with the third building element, confirming installation for the first building element during the first lift event.

15. A method of tracking progress at a construction site comprising:
for a first lift event at a crane during a first time, accessing first lift event data comprising:
a first pickup location;
a first element weight;
a first drop-off location; and
a first drop-off time;
based on the first pickup location and the first element weight, correlating the first lift event with a first building element;
for a second lift event at a crane during a second time, accessing a second lift event data comprising:
a second pickup location;
a second element weight;
a second drop-off location; and
a second drop-off time;
based on the second pickup location and the second element weight, correlating the second lift event with a second building element;
detecting a first group of the first building element and the second building element based on:
a proximity of the first drop-off location and the second drop-off location; and
a proximity of the first drop-off time and the second drop-off time;
identifying a group archetype, from a set of group archetypes, associated with the first group, the group archetype defining rules for installation of a set of building elements within the first group; and
in response to detection of a difference between the group archetype and the first lift event data and the second lift event data:
generating a notification indicating a digression from the group archetype; and
transmitting the notification to an operator.

16. The method of claim 15, further comprising:
accessing a first timeseries of load values representing a load on the hook of the crane during a first time period;
accessing a first timeseries of motion values representing a motion of the hook of the crane during the first time period;
accessing a first geospatial location during loading of the element at the first time period;
deriving a first weight of the element based on the first timeseries of load values;
detecting a first oscillation of the hook of the crane at the first geospatial location from the first timeseries of motion values;
deriving the first lifting profile at the first geospatial location based on the first timeseries of load values and the first oscillation;
accessing a second geospatial location of the smart hook during unloading of the element from the smart hook at the first time period; and
generating a lift event record defining the element type, the first weight of the element, a pickup location of the element at the first geospatial location, and the drop off location of the element at the second geospatial location.

17. The method of claim 15, further comprising:
generating a prompt for an operator of a computer system to input:
an installation order for a group of building elements; and
a target installation duration for each building element of the group of building elements;
transmitting the prompt to the operator of the computer system; and
storing the installation order and target installation duration within a group archetype of the set of group archetypes.

18. The method of claim 15, further comprising:
for the first group of the first building element and the second building element:
identifying a second group of building elements installed before the first group of building elements, the second group of building elements defining a set of building element types corresponding to the building element types of the first building element and the second building element;
accessing a building element installation order of the second group; and
accessing an installation duration for each building element of the second group; and
deriving, based on the building element installation order of the second group and the installation duration for each building element of the second group;
a building element installation order for building elements within the first group; and
a target installation duration for each building element within the first group.

19. The method of claim 15:
wherein identifying the group archetype comprises the group archetype defining an installation order indicating the first building element installed before the second building elements within a target duration; and
further comprising:
detecting installation of the second building element before installation of the first building element;
detecting an installation duration less than the target duration; and
generating a notification comprising a prompt for an operator to approve a revision of the group archetype, the revision comprising updating the installation order to reflect the second building element installed before the first.

20. The method of claim 15, further comprising:
rendering a virtual building model on a display, the virtual building model comprising:
a first virtual element representing the first building element; and
a second virtual element representing the second building element; and
in response to detection of a difference between the group archetype and the first lift event data and the second lift event data:
rendering the first virtual element and the second virtual element in a color corresponding to a detected error.
